(19) United States
(12) Patent Application Publication
(10) Pub. No.: US 2023/0034349 A1
(43) Pub. Date: Feb. 2, 2023

(54) EDGE SERVICES CONFIGURATION

(71) Applicant: INTERDIGITAL PATENT HOLDINGS, INC., Wilmington, DE (US)

(72) Inventors: Catalina MLADIN, Hatboro, PA (US); Michael STARSINIC, Newtown, PA (US); Quang LY, North Wales, PA (US); Hongkun LI, Malvern, PA (US); Jiwan NINGLEKHU, Royersford, PA (US); Dale SEED, Allentown, PA (US)

(21) Appl. No.: 17/789,572

(22) PCT Filed: Dec. 17, 2020
(86) PCT No.: PCT/US2020/065702

§ 371 Date: Jun. 28, 2022

Related U.S. Application Data
(60) Provisional application No. 62/955,506, filed on Dec. 31, 2019.
(60) Provisional application No. 63/018,582, filed on May 1, 2020.

(51) Int. Cl. H04W 48/08; H04W 76/12

(52) U.S. Cl. CPC H04W 48/08; H04W 76/12

(57) ABSTRACT

Methods devised for enabling external AF/AS to provide information to SGC regarding Edge Data Network Configurations. Further, methods for UE provisioning for Edge service enablement are provided. Mechanisms are disclosed for: enabling UEs, not hosting an EEC, to request EDN information provisioning in order to enable Application Clients, which are not Edge-aware, to utilize Edge services; enabling an EEC, hosted by a UE, to obtain Edge Configuration information by using URSP rules for establishing IP connectivity with a Configuration Server; and enabling an EEC, hosted by a UE, to obtain Edge Data Network configuration information during registration. Furthermore, methods are provided that include mechanisms for: enabling AFs to subscribe for event monitoring exposure via the NEF and request optimized reporting or preference for reporting distribution via the UE; enabling subscriptions and policies from centralized NFs to be distributed to Edge or Local Deployments along the path of UEs, via the UE; and enabling exposure of event monitoring from centralized NFs to edge servers, with low latency, via the UE.

### CROSS-REFERENCE TO RELATED APPLICATIONS

This application claims the benefit of U.S. Patent Application Ser. No. 62/955,506, filed on Dec. 31, 2019, titled “Edge Services Configuration,” and U.S. Patent Application Ser. No. 63/018,582, filed on May 1, 2020, also titled “Edge Services Configuration,” the contents of which are hereby incorporated by reference in their entireties.

### BACKGROUND

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. The development of 3GPP NR standards is expected to continue and include the definition of next generation radio access technology (new RAT), which is expected to include the provision of new flexible radio access below 7 GHz, and the provision of new ultra-mobile broadband radio access above 7 GHz. The flexible radio access is expected to consist of a new, non-backwards compatible radio access in new spectrum below 7 GHz, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB), ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive eCall, disaster alerts, real-time gaming, multi-person video calls, autonomous driving, augmented reality, tactile internet, virtual reality, home automation, robotics, and aerial drones to name a few. All of these use cases and others are contemplated herein.

### SUMMARY

Aspects disclosed herein describe methods enabling external AF/AS to provide information to 5GC regarding Edge Data Network Configurations. Further aspects disclosed herein describe mechanisms addressing UE provisioning for Edge service enablement, such as: 1) mechanisms enabling UEs not hosting EEC to request EDN information provisioning in order to enable Application Clients which are not Edge-aware to utilize Edge services, such mechanisms may be based on the UE registration procedure and on the provisioning and use of URSP rules; 2) mechanism enabling the EEC hosted by a UE to obtain Edge Configuration information by using URSP rules for establishing IP connectivity with the Configuration Server; and 3) mechanism enabling the EEC hosted by a UE to obtain Edge Data Network configuration information during registration.

Additional aspects disclosed herein describe methods enabling network information exposure with low latency at the edge such as: 1) mechanisms that enable AFs to subscribe for event monitoring exposure via NEF and request optimized reporting (e.g. with low latency) or preference for reporting distribution via the UE; 2) mechanisms that enable subscriptions and policies from centralized NFs to be distributed to Edge or Local Deployments along the path of UEs, via the UE; and 3) mechanisms that enable exposure of event monitoring from centralized NFs to edge servers, with low latency, via the UE.

### BRIEF DESCRIPTION OF THE DRAWINGS

A more detailed understanding may be had from the following description, given by way of example in conjunction with accompanying drawings wherein:

FIG. 1A illustrates an example communications system.

FIGS. 1B, 1C, and 1D are system diagrams of example RANs and core networks.

FIG. 1E illustrates another example communications system.

FIG. 1F is a block diagram of an example apparatus or device, such as a WTRU.

FIG. 1G is a block diagram of an example computing system.

FIG. 2 illustrates the use of Edge & Cloud V2X Application Servers by V2X ACs on UEs.

FIG. 3 illustrates a 3GPP defined architecture for enabling edge applications. (See 3GPP TR 23.758, Study on Application Architecture for Enabling Edge Applications, v1.0.0 (2019-09)).

FIGS. 4A, 4B, and 4C show a call flow of an example Enhanced Registration procedure (no EEC case).

FIGS. 5A and 5B show a call flow of an example enhanced UE-requested PDU Session Establishment.

FIGS. 6A and 6B show a call flow of an example enhanced registration procedure (EEC-based case).

FIG. 7 is a system diagram of an example core network architecture with network functions.

FIG. 8 is an example of an example unoptimized network exposure reporting path for an edge deployment.

FIG. 9 is an example of an example optimized reporting path from a centralized network function.

FIG. 10 is a call flow of an example of forwarding of edge reporting subscriptions from a centralized network exposure function.

FIG. 11 is a call flow of an example routing/distributing of edge monitoring policies via the UE.

FIG. 12 is a call flow of an example reporting routing from a centralized NF via the UE.

FIGS. 13A-E show a call flow of an example enhanced registration procedure enabling a UE to communicate its support for routing monitoring reports.

FIG. 14 illustrates an example of optimized reporting path from a locally deployed NF.

### DETAILED DESCRIPTION

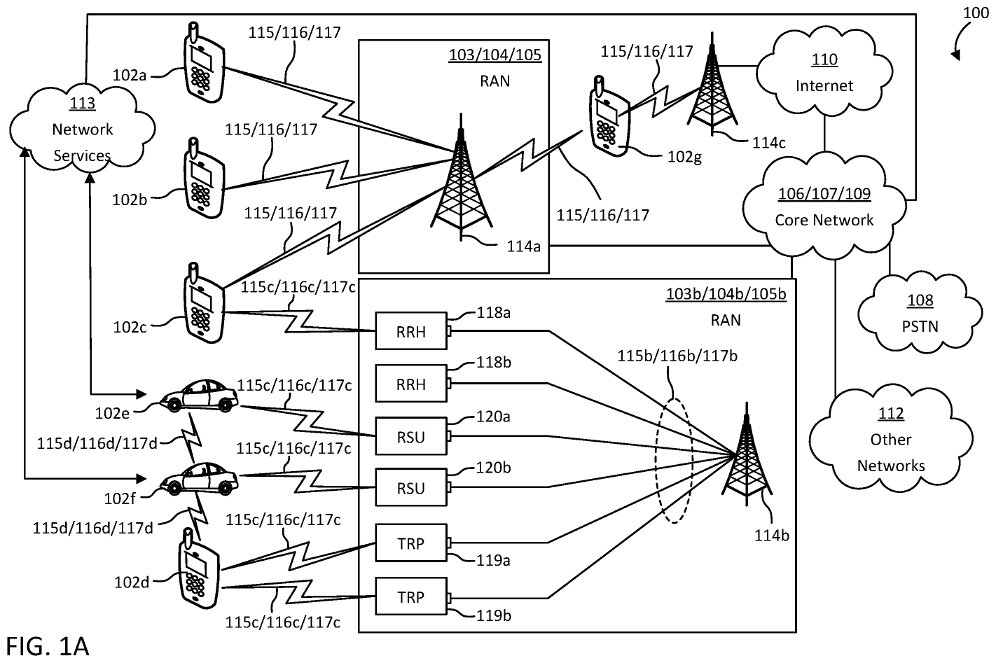

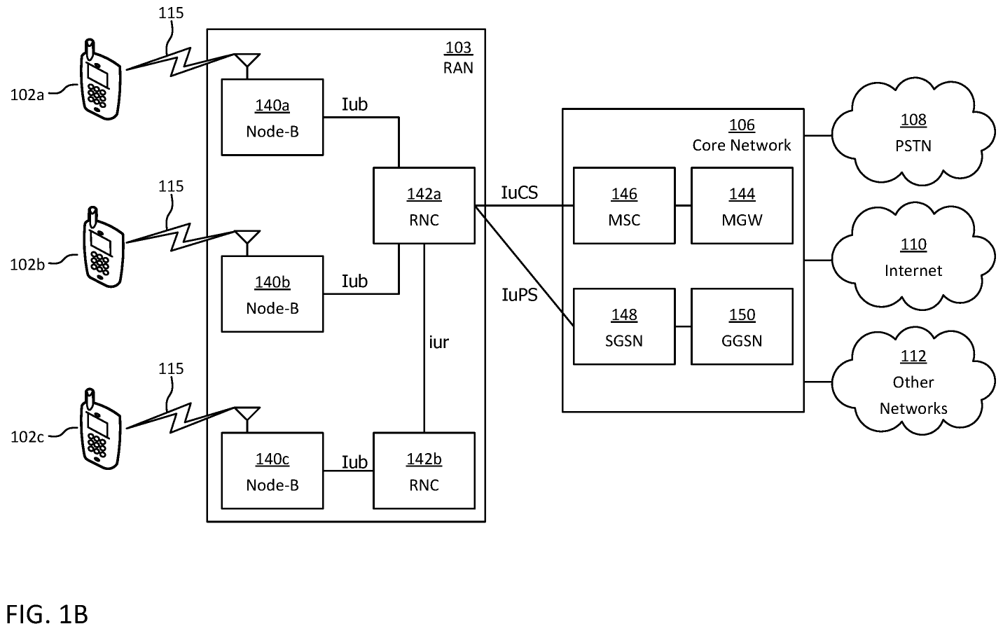

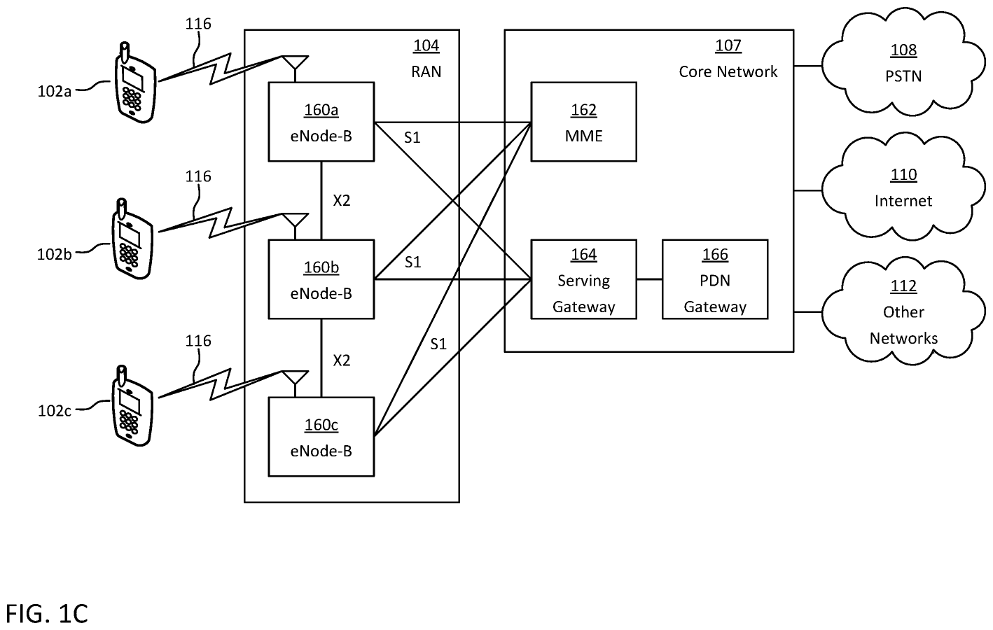

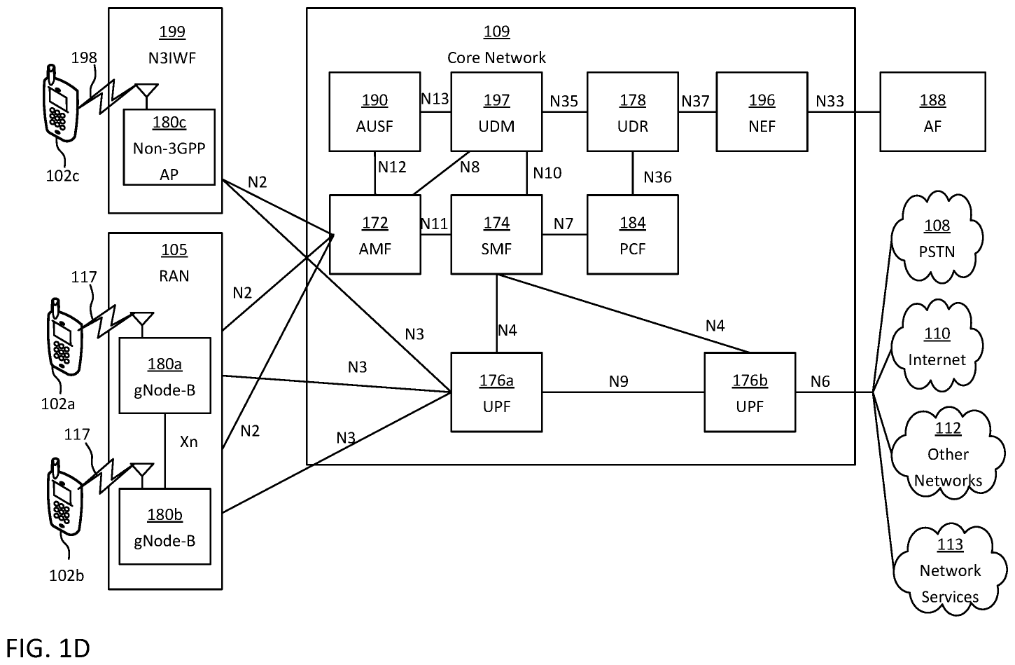

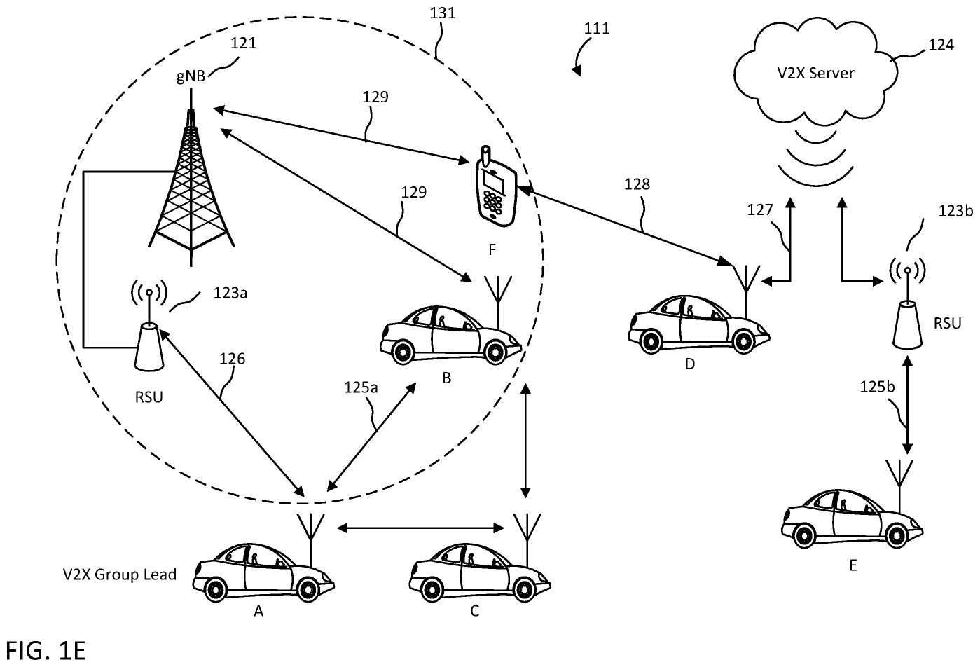

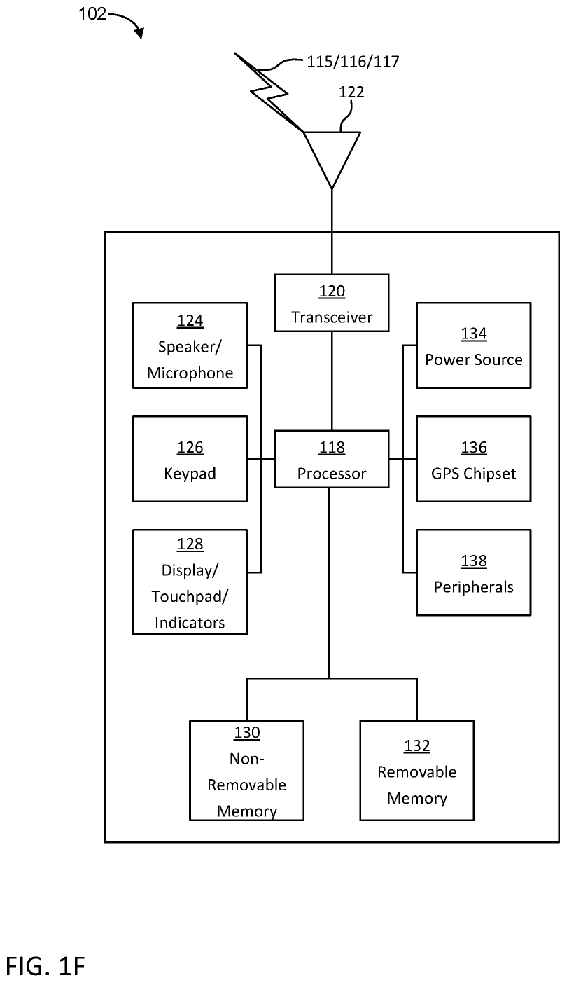

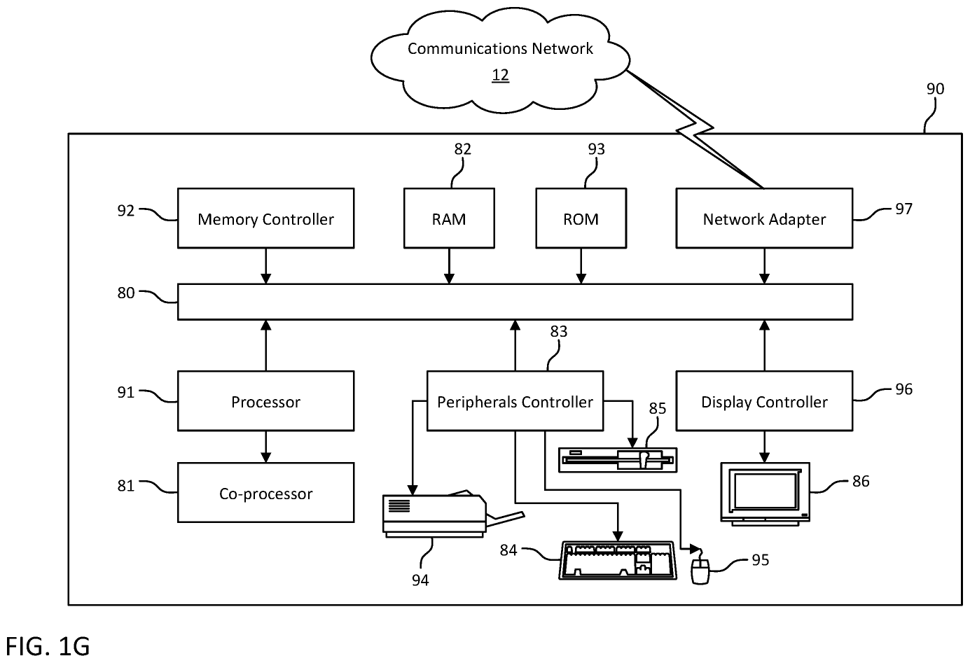

FIG. 1A illustrates an example communications system 100 in which the systems, methods, and apparatuses described and claimed herein may be used. The communications system 100 may include wireless transmit/receive units (WTRUs) 102a, 102b, 102c, 102d, 102e, 102f, and/or 102g, which generally or collectively may be referred to as WTRU 102 or WTRUs 102. The communications system 100 may include, a radio access network (RAN) 103/104/105/103b/104b/105b, a core network 106/107/109, a public switched telephone network (PSTN) 108, the Internet 110, other networks 112, and Network Services 113. Network Services 113 may include, for example, a V2X server, V2X functions, a ProSe server, ProSe functions, IoT services, video streaming, and/or edge computing, etc.

It will be appreciated that the concepts disclosed herein may be used with any number of WTRUs, base stations, networks, and/or network elements. Each of the WTRUs 102 may be any type of apparatus or device configured to operate and/or communicate in a wireless environment. In the example of FIG. 1A, each of the WTRUs 102 is depicted in FIGS. 1A-1E as a hand-held wireless communications apparatus. It is understood that with the wide variety of use cases contemplated for wireless communications, each WTRU may comprise or be included in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus or truck, a train, or an airplane, and the like.

The communications system 100 may also include a base station 114a and a base station 114b. In the example of FIG. 1A, each base stations 114a and 114b is depicted as a single element. In practice, the base stations 114a and 114b may include any number of interconnected base stations and/or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, and/or the other networks 112. Similarly, base station 114b may be any type of device configured to wiredly and/or wirelessly interface with at least one of the Remote Radio Heads (RRHs) 118a, 118b, Transmission and Reception Points (TRPs) 119a, 119b, and/or Roadside Units (RSUs) 120a and 120b to facilitate access to one or more communication networks, such as the core network 106/107/109, the Internet 110, other networks 112, and/or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, and/or other networks 112.

TRPs 119a, 119b may be any type of device configured to wirelessly interface with at least one of the WTRU 102d, to facilitate access to one or more communication networks, such as the core network 106/107/109, the Internet 110, Network Services 113, and/or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, and/or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations and/or network elements (not shown), such as a Base Station Controller (BSC), a Radio Network Controller (RNC), relay nodes, etc. Similarly, the base station 114b may be part of the RAN 103b/104b/105b, which may also include other base stations and/or network elements (not shown), such as a BSC, a RNC, relay nodes, etc. The base station 114a may be configured to transmit and/or receive wireless signals within a particular geographic region, which may be referred to as a cell (not shown). Similarly, the base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, for example, the base station 114a may include three transceivers, e.g., one for each sector of the cell. The base station 114a may employ Multiple-Input Multiple Output (MIMO) technology and, therefore, may utilize multiple transceivers for each sector of the cell, for instance.

The base station 114a may communicate with one or more of the WTRUs 102a, 102b, 102c, and 102g over an air interface 115/116/117, which may be any suitable wireless communication link (e.g., Radio Frequency (RF), microwave, infrared (IR), ultraviolet (UV), visible light, cmWave, mmWave, etc.). The air interface 115/116/117 may be established using any suitable Radio Access Technology (RAT).

The base station 114b may communicate with one or more of the RRHs 118a and 118b, TRPs 119a and 119b, and/or RSUs 120a and 120b, over a wired or air interface 115b/116b/117b, which may be any suitable wired (e.g., cable, optical fiber, etc.) or wireless communication link (e.g., RF, microwave, IR, UV, visible light, cmWave, mmWave, etc.). The air interface 115b/116b/117b may be established using any suitable RAT.

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., RF, microwave, IR, ultraviolet UV, visible light, cmWave, mmWave, etc.) The air interface 115c/116c/117c may be established using any suitable RAT.

The WTRUs 102 may communicate with one another over a direct air interface 115d/116d/117d, such as Sidelink communication which may be any suitable wireless communication link (e.g., RF, microwave, IR, ultraviolet UV, visible light, cmWave, mmWave, etc.) The air interface 115d/116d/117d may be established using any suitable RAT.

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and/or RSUs 120a and 120b in the RAN 103b/104b/105b and the WTRUs 102c, 102d, 102e, and 102f, may implement a radio technology such as Universal Mobile Telecommunications System (UMTS) Terrestrial Radio Access (UTRA), which may establish the air interface 115/116/117 and/or 115c/116c/117c respectively using Wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

The base station 114a in the RAN 103/104/105 and the WTRUs 102a, 102b, 102c, and 102g, or RRHs 118a and 118b, TRPs 119a and 119b, and/or RSUs 120a and 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A), for example. The air interface 115/116/117 or 115c/116c/117c may implement 3GPP NR technology. The LTE and LTE-A technology may include LTE D2D and/or V2X technologies and interfaces (such as Sidelink communications, etc.) Similarly, the 3GPP NR technology may include NR V2X technologies and interfaces (such as Sidelink communications, etc.)

The base station 114a in the RAN 103/104/105 and the WTRUs 102a, 102b, 102c, and 102g or RRHs 118a and 118b, TRPs 119a and 119b, and/or RSUs 120a and 120b in the RAN 103b/104b/105b and the WTRUs 102c, 102d, 102e, and 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 1A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like. The base station 114c and the WTRUs 102, e.g., WTRU 102e, may implement a radio technology such as IEEE 802.11 to establish a Wireless Local Area Network (WLAN). Similarly, the base station 114c and the WTRUs 102, e.g., WTRU 102d, may implement a radio technology such as IEEE 802.15 to establish a wireless personal area network (WPAN). The base station 114c and the WTRUs 102, e.g., WRTU 102e, may utilize a cellular-based RAT (e.g., WCDMA, CDMA2000, GSM, LTE, LTE-A, NR, etc.) to establish a picocell or femtocell. As shown in FIG. 1A, the base station 114c may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, messaging, authorization and authentication, applications, and/or Voice Over Internet Protocol (VoIP) services to one or more of the WTRUs 102. For example, the core network 106/107/109 may provide call control, billing services, mobile location-based services, pre-paid calling, Internet connectivity, packet data network connectivity, Ethernet connectivity, video distribution, etc., and/or perform high-level security functions, such as user authentication.

Although not shown in FIG. 1A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102 to access the PSTN 108, the Internet 110, and/or other networks 112. The PSTN 108 may include circuit-switched telephone networks that provide Plain Old Telephone Service (POTS). The Internet 110 may include a global system of interconnected computer networks and devices that use common communication protocols, such as the Transmission Control Protocol (TCP), User Datagram Protocol (UDP), and the internet protocol (IP) in the TCP/IP internet protocol suite. The other networks 112 may include wired or wireless communications networks owned and/or operated by other service providers. For example, the networks 112 may include any type of packet data network (e.g., an IEEE 802.3 Ethernet network) or another core network connected to one or more RANs, which may employ the same RAT as the RAN 103/104/105 and/or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links. For example, the WTRU 102g shown in FIG. 1A may be configured to communicate with the base station 114a, which may employ a cellular-based radio technology, and with the base station 114c, which may employ an IEEE 802 radio technology.

Although not shown in FIG. 1A, it will be appreciated that a User Equipment may make a wired connection to a gateway. The gateway may be a Residential Gateway (RG). The RG may provide connectivity to a Core Network 106/107/109. It will be appreciated that many of the ideas contained herein may equally apply to UEs that are WTRUs and UEs that use a wired connection to connect to a network. For example, the ideas that apply to the wireless interfaces 115, 116, 117 and 115c/116c/117c may equally apply to a wired connection.

FIG. 1B is a system diagram of an example RAN 103 and core network 106. As noted above, the RAN 103 may employ a UTRA radio technology to communicate with the WTRUs 102a, 102b, and 102c over the air interface 115. The RAN 103 may also be in communication with the core network 106. As shown in FIG. 1B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It will be appreciated that the RAN 103 may include any number of Node-Bs and Radio Network Controllers (RNCs.)

As shown in FIG. 1B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 1B may include a media gateway (MGW) 144, a Mobile Switching Center (MSC) 146, a Serving GPRS Support Node (SGSN) 148, and/or a Gateway GPRS Support Node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned and/or operated by other service providers.

FIG. 1C is a system diagram of an example RAN 104 and core network 107. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 1C, the eNode-Bs 160a, 160b, and 160c may communicate with one another over an X2 interface.

The core network 107 shown in FIG. 1C may include a Mobility Management Gateway (MME) 162, a serving gateway 164, and a Packet Data Network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned and/or operated by other service providers.

FIG. 1D is a system diagram of an example RAN 105 and core network 109. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It will be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, and/or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It will also be appreciated the RAN 105 may employ more than one type of base station. For example, the RAN may employ eNode-Bs and gNode-Bs.

The N3IWF 199 may include a non-3GPP Access Point 180c. It will be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink and/or downlink, and the like. As shown in FIG. 1D, the gNode-Bs 180a and 180b may communicate with one another over an Xn interface, for example.

The core network 109 shown in FIG. 1D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless and/or network communications or a computer system, such as system 90 illustrated in FIG. x1G.

In the example of FIG. 1D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it will be appreciated that any one of these elements may be owned and/or operated by an entity other than the core network operator. It will also be appreciated that a 5G core network may not consist of all of these elements, may consist of additional elements, and may consist of multiple instances of each of these elements. FIG. 1D shows that network functions directly connect to one another, however, it should be appreciated that they may communicate via routing agents such as a diameter routing agent or message buses.

In the example of FIG. 1D, connectivity between network functions is achieved via a set of interfaces, or reference points. It will be appreciated that network functions could be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 1D.

The SMF 174 may be connected to the AMF 172 via an N11 interface. Similarly the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF 176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 1D. The PCF 184 may provide policy rules to control plane nodes such as the AMF 172 and SMF 174, allowing the control plane nodes to enforce these rules. The PCF 184, may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect to network functions, so that network function can add to, read from, and modify the data that is in the repository. For example, the UDR 178 may connect to the PCF 184 via an N36 interface. Similarly, the UDR 178 may connect to the NEF 196 via an N37 interface, and the UDR 178 may connect to the UDM 197 via an N35 interface.

The UDM 197 may serve as an interface between the UDR 178 and other network functions. The UDM 197 may authorize network functions to access of the UDR 178. For example, the UDM 197 may connect to the AMF 172 via an N8 interface, the UDM 197 may connect to the SMF 174 via an N10 interface. Similarly, the UDM 197 may connect to the AUSF 190 via an N13 interface. The UDR 178 and UDM 197 may be tightly integrated.

The AUSF 190 performs authentication related operations and connects to the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect to an AF 188 via an N33 interface and it may connect to other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that could be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g. in the areas of functionality, performance and isolation.

3GPP has designed the 5G core network to support Network Slicing. Network Slicing is a good tool that network operators can use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 1D, in a network slicing scenario, a WTRU 102a, 102b, or 102c may connect to an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, that serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned and/or operated by other service providers.

The core network entities described herein and illustrated in FIGS. 1A, 1C, 1D, and 1E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 1A, 1B, 1C, 1D, and 1E are provided by way of example only, and it is understood that the subject matter disclosed and claimed herein may be embodied or implemented in any similar communication system, whether presently defined or defined in the future.

FIG. 1E illustrates an example communications system 111 in which the systems, methods, apparatuses described herein may be used. Communications system 111 may include Wireless Transmit/Receive Units (WTRUs) A, B, C, D, E, F, a base station gNB 121, a V2X server 124, and Road Side Units (RSUs) 123a and 123b. In practice, the concepts presented herein may be applied to any number of WTRUs, base station gNBs, V2X networks, and/or other network elements. One or several or all WTRUs A, B, C, D, E, and F may be out of range of the access network coverage 131. WTRUs A, B, and C form a V2X group, among which WTRU A is the group lead and WTRUs B and C are group members.

WTRUs A, B, C, D, E, and F may communicate with each other over a Uu interface 129 via the gNB 121 if they are within the access network coverage 131. In the example of FIG. 1E, WTRUs B and F are shown within access network coverage 131. WTRUs A, B, C, D, E, and F may communicate with each other directly via a Sidelink interface (e.g., PC5 or NR PC5) such as interface 125a, 125b, or 128, whether they are under the access network coverage 131 or out of the access network coverage 131. For instance, in the example of FIG. 1E, WRTU D, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 1F is a block diagram of an example apparatus or device WTRU 102 that may be configured for wireless communications and operations in accordance with the systems, methods, and apparatuses described herein, such as a WTRU 102 of FIG. 1A, 1B, 1C, 1D, or 1E. As shown in FIG. 1F, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements. Also, the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 1F and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1F depicts the processor 118 and the transceiver 120 as separate components, it will be appreciated that the processor 118 and the transceiver 120 may be integrated together in an electronic package or chip.

The transmit/receive element 122 of a UE may be configured to transmit signals to, or receive signals from, a base station (e.g., the base station 114a of FIG. 1A) over the air interface 115/116/117 or another UE over the air interface 115d/116d/117d. For example, the transmit/receive element 122 may be an antenna configured to transmit and/or receive RF signals. The transmit/receive element 122 may be an emitter/detector configured to transmit and/or receive IR, UV, or visible light signals, for example. The transmit/receive element 122 may be configured to transmit and receive both RF and light signals. It will be appreciated that the transmit/receive element 122 may be configured to transmit and/or receive any combination of wireless or wired signals.

In addition, although the transmit/receive element 122 is depicted in FIG. 1F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit. The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 118 may access information from, and store data in, memory that is not physically located on the WTRU 102, such as on a server that is hosted in the cloud or in an edge computing platform or in a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method.

The processor 118 may further be coupled to other peripherals 138, which may include one or more software and/or hardware modules that provide additional features, functionality, and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect to other components, modules, or systems of such apparatuses or devices via one or more interconnect interfaces, such as an interconnect interface that may comprise one of the peripherals 138.

FIG. 1G is a block diagram of an example computing system 90 in which one or more apparatuses of the communications networks illustrated in FIGS. 1A, 1C, 1D and 1E may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIGS. 1A, 1B, 1C, 1D, and 1E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations, or functions described herein may be implemented in the form of such computer executable instructions, executing on the processor of an apparatus or computing system configured for wireless and/or wired network communications. Computer readable storage media includes volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

The following is a list of acronyms that may appear in the following description. Unless otherwise specified, the acronyms used herein refer to the corresponding terms listed below:
5GC 5G Core Network
AF Application Function
AMF Access Management Function
API Application Programming Interface
AS Application Server
AC Application Client
BS Binding Function
CN Core Network
DNN Data Network Name
DNS Domain Name Server
EAS Edge Application Server
EDN Edge Data Network
ECSP Edge Computing Service Provider
EDNCS Edge Data Network Configuration Server
EES Edge Enable Server
EEC Edge Enabler Client
EHE Edge Hosting Environment
EMRP Edge Monitoring Routing Policy
FQDN Fully Qualified Domain Name
GMLC Gateway Mobile Location Centre
GUI Graphical User Interface
LADN Local Area Data Network
NEF Network Exposure Function
NF Network Function
PDU Protocol Data Unit
SMF Session Management Function
UDM Unified Data Management
UE User Equipment
UP User Plane

Application Server—An entity deployed on a network node that provides services to Application Clients.

Application Client—An entity that accesses the services of an Application Server.

Edge Application Server— A server providing application services that is hosted on an edge node or an Edge Hosting Environment.

Edge Node— A virtual or physical entity deployed within an edge network and that hosts edge-based applications and services.

Edge Data Network—Local Data Network that supports distributed deployment of Edge Hosting Environments. In the present disclosure, the term Edge Data Networks may be used interchangeably with the term Edge Hosting Environment. For example, Servers described herein to be in the Edge Data Network are running on a corresponding Edge Hosting Environment.

Edge Enabler Server—An entity deployed within an edge network that provides edge network centric services to Edge Enabler Clients and Edge Application Servers. In some 3GPP specifications Edge Enabler Servers are not distinguished functionally from Edge Application Servers, and the term “Edge Application Server” may be applied to both.

Edge Enabler Client—An entity deployed on a device that provides edge network centric services to Application Clients hosted on the device.

Edge Data Network Configuration Server—An entity in the network that configures Edge Enabler Clients and Edge Enabler Servers to enable the services provided by the Edge Data Network. Edge Data Network Configuration Servers may also be termed Edge Configuration Servers.

Edge Hosting Environment—An environment providing support required for Edge Application Server's execution.

Edge Application Deployments.

The benefits of deploying Application Servers (ASs) at the edge of a 3GPP system rather than in the cloud may include reduced access latency and increased reliability for Application Clients (ACs) which access the services offered by these ASs. In addition, network operators may also benefit from the deployment of ASs at the edge of their networks since this model of deployment may allow them to distribute the load and reduce congestion levels in their networks (e.g., by enabling localized communication between ACs and ASs).

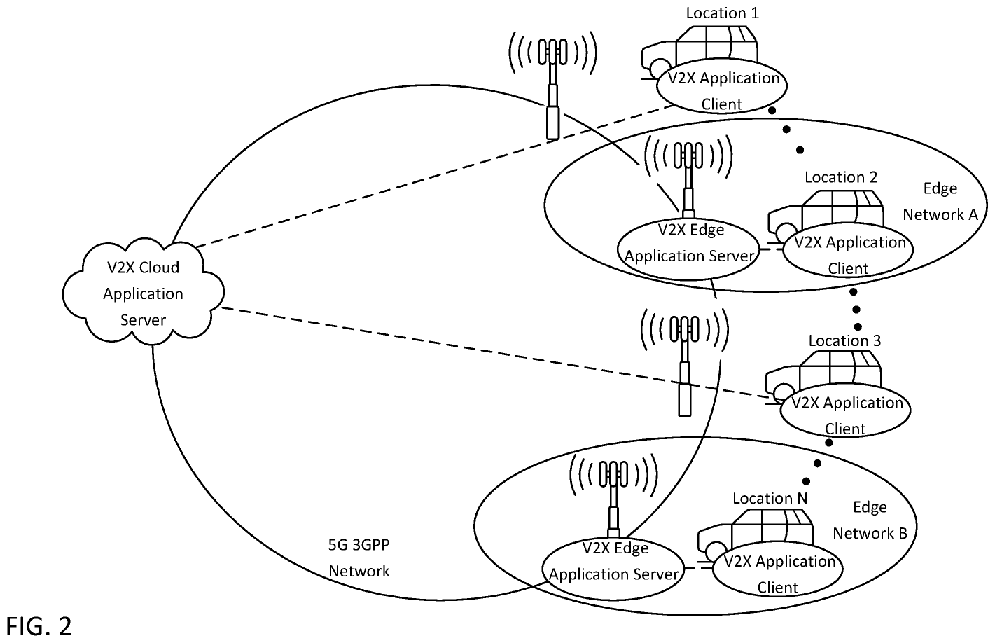

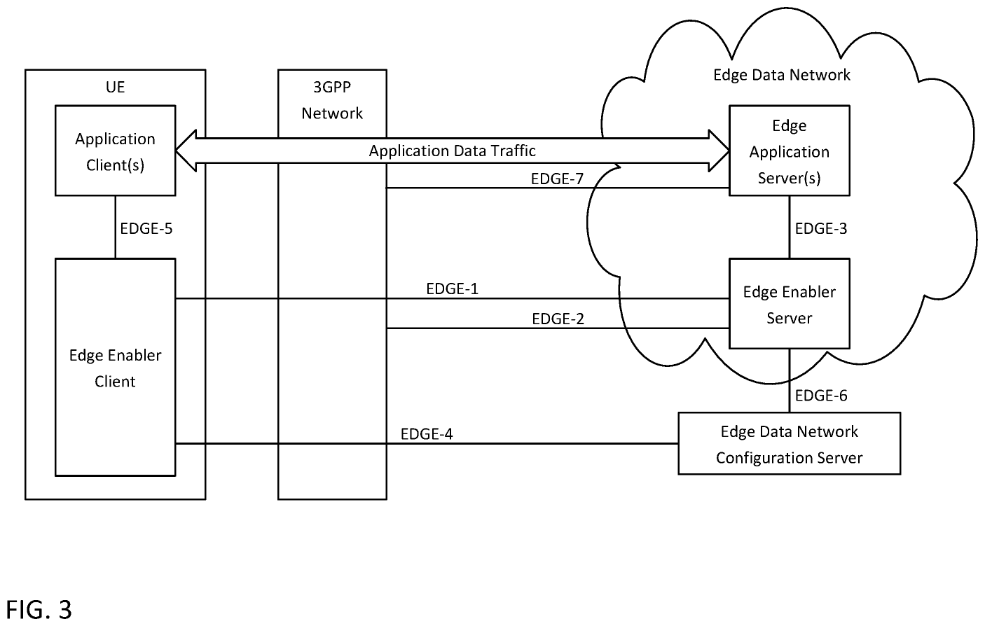

For example, FIG. 2 illustrates an autonomous vehicular use case. A vehicle hosts a UE and hosted on the UE is a V2X AC used by the vehicle's autonomous driving control system. The V2X AC communicates with V2X services deployed in a 3GPP system (e.g., platooning service, cooperative driving service, or collision avoidance service). The V2X services may be deployed in a distributed manner across the system as a combination of V2X ASs deployed on edge nodes (e.g., road-side units or cell towers) as well as in the cloud.

For enhanced performance (e.g., reduced access latency and higher reliability), the preferred method for accessing the V2X services by V2X ACs may be via V2X ASs that are deployed in edge networks in the system which are typically in closer proximity to the vehicles rather than accessing V2X ASs via the cloud. When accessing the V2X ASs at the edge, a V2X AC hosted on the UE within the vehicle may take advantage of timelier and more reliable information regarding other vehicles and conditions of the roadway and traffic. As a result, the vehicle can travel at higher rates of speed and at closer distances to other vehicles. The vehicle may also be able to change lanes more often and effectively without sacrificing safety. In contrast, when accessing V2X ASs in the cloud, the vehicle may have to fall back into a more conservative mode of operation due to the decreased availability of timely information. This typically may result in a reduction in the vehicle's speed, an increase in distance between the vehicle and other vehicles and/or less than optimal lane changes.

As vehicles travel down roadways, handovers of V2X ACs between V2X ASs hosted on different edge nodes in closest proximity to the vehicles may have to be coordinated. Likewise, handovers of V2X ACs between V2X ASs hosted on edge nodes and V2X ASs hosted in the cloud may also have to be coordinated for cases where edge network coverage fades in and out during a vehicle's journey. For such scenarios, seamless (that is low latency and reliable) V2X AC handovers, between ASs hosted on both edge nodes as well as in the cloud, may be critical and essential for the successful deployment of this type of V2X use case as well as other types of use cases having similar requirements as V2X.

A 3GPP Architecture for Enabling Edge Applications.

Error! Reference source not found. shows the 3GPP defined architecture for enabling edge applications. The Framework for enabling edge applications may comprise an Edge Enabler Client and Application Client(s) hosted on the UE, and an Edge Enabler Server and Edge Application Server(s) hosted in an edge data network. An Edge Data Network Configuration Server may be used to configure Edge Enabler Clients and Edge Enabler Servers. The Edge Enabler Client and Server may offer edge centric capabilities to Application Clients and Servers, respectively. The Edge Enabler server and Edge Data Network Configuration Server may also interact with the 3GPP network.

3GPP Architecture for Network Exposure.

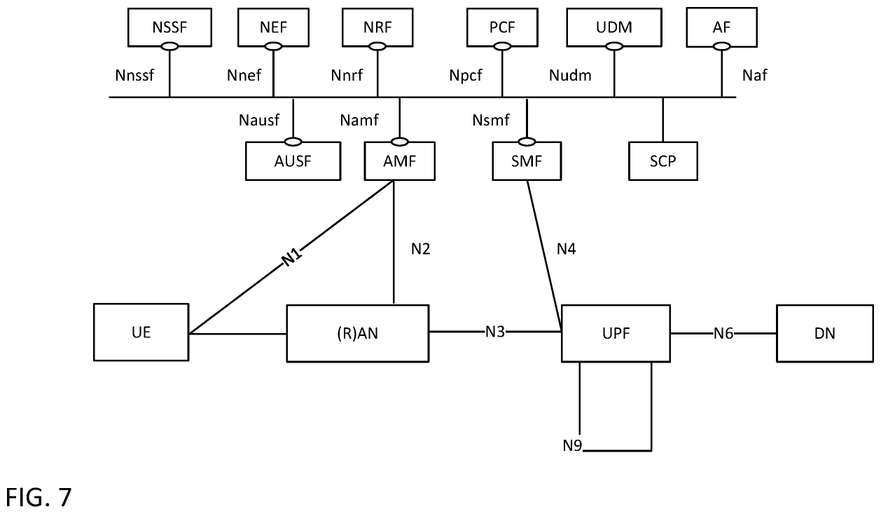

FIG. 7 is a system diagram of core network architecture with network functions, as described below. Current network exposure mechanisms in 5GS may be designed based on an NEF and other control plane NFs, e.g., AMF, SMF, or PCF. NEF (as described in 3GPP TS 23.501, System Architecture for the 5G System; Stage 2, V16.3.0 (2019-12)) may include the following functionality.
Exposure of capabilities and events, securely, for 3rd party, Application Functions, etc.
NEF stores/retrieves information as structured data using a standardized interface (Nudr) to the Unified Data Repository (UDR).
Secure provision of information from external application to 3GPP network. It provides a means for the Application Functions to securely provide information to 3GPP network, e.g., Expected UE Behaviour, 5GLAN group information or service specific information. In that case, the NEF may authenticate, authorize, and assist in throttling the Application Functions.
Translation of internal-external information. The translation is between information exchanged with the AF and information exchanged with the internal network function. For example, the translation may be between an AF-Service-Identifier and internal 5G Core information such as DNN, or S-NSSAI.
In particular, NEF handles masking of network and user sensitive information to external AF's according to the network policy.
The Network Exposure Function receives information from other network functions (based on exposed capabilities of other network functions). An NEF stores the received information as structured data using a standardized interface to a Unified Data Repository (UDR). The stored information can be accessed and “re-exposed” by the NEF to other network functions and Application Functions and used for other purposes such as analytics.
An NEF may support a Packet Flow Description Function by storing and retrieving PFD(s) in the UDR and providing PFD(s) to the SMF on the request of SMF (pull mode) or on the request of PFD management from NEF (push mode).
An NEF may also support a 5GLAN Group Management Functions.
Exposure of analytics. NWDAF analytics may be securely exposed by NEF for external party, as specified in TS 23.288.
Retrieval of data from external party by NWDAF. Data provided by the external party may be collected by NWDAF via NEF for analytics generation purpose. An NEF handles and forwards requests and notifications between an NWDAF and an AF, as specified in TS 23.288.

A specific NEF instance may support one or more of the functionalities described above and consequently an individual NEF may support a subset of the APIs specified for capability exposure. An NEF can access the UDR that may be located in the same PLMN as the NEF. For external exposure of services related to specific UE(s), the NEF may reside in the HPLMN. Depending on operator agreements, the NEF in the HPLMN may have interface(s) with NF(s) in the VPLMN.

Problem Statement.

SA6 has designed an Edge Computing Application Layer Architecture. In this architecture, Application Client(s) on the UE may access the services of Edge Enabler Client(s) on the UE. Application Client(s) on the UE may also communicate with Edge Application Servers(s). Edge Application Servers(s) may reside in edge data networks. Servers at the edge may interact with the 5GS to access functionality and information exposed by the network. Currently, the exposure may be provided via Control Plane NFs, e.g., NEF or PCF, which are likely to be centrally deployed to avoid relocation. If an Application Client on the UE uses SA6 defined procedures and APIs to access an Edge Enabler Client, it is said to be “edge-aware.”

In the SA6 architecture, Edge Enabler Clients may communicate with an EDN Configuration Server which may be hosted in the N6-LAN (i.e., the EDN Configuration Server may not be deployed in the edge). The Edge Enabler Client may communicate with the EDN Configuration Server in order to obtain information such as: what Edge Data Networks are available in a given location or what Edge Applications Servers are available. Thus, Edge Enabler Clients may have to establish communications with an EDN Configuration Server and obtain configuration information before it can provide services to Application Clients. 3GPP has not defined a means for Edge Enabler Clients to discover EDN Configuration Servers.

In other scenarios, Application Clients on the UE may not be “edge aware.” Thus, for example, they do not communicate with Edge Enabler Clients and do not follow 3GPP application layer protocols.

In scenarios where applications on the UE can make use of edge services although the Application Client is not “edge aware,” 3GPP has not defined how a UE protocol stack may know where to send application data when edge computing is enabled. In other words, there is no way for the UE to independently (with no application help) determine when to route data to the edge. For example, consider the case where smart phone hosts applications that are not edge aware. The smart phone may display a GUI that allows the user to indicate on which applications the user wants to enable edge computing. There is no way for the UE protocol stack to enable edge computing on the indicated applications if they are not “edge aware.”

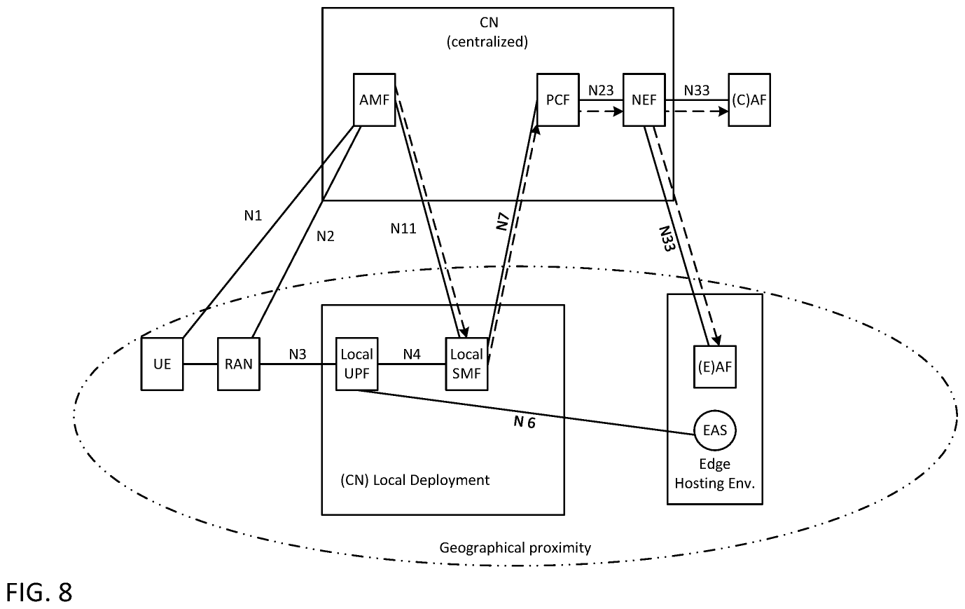

When edge services rely on network exposure information (e.g., reports) from the NEF, a long delay in the report traveling from the network to the edger server may make the information obsolete by the time it reaches the edge server. This may in turn cause application behavior changes (e.g., adjusting video stream resolution or switching levels of driving automation) based on out-of-date network information. Thus, one problem that needs to be addressed is how network exposure information (e.g., reports) can be delivered to the edge server in a more timely or optimized manner. If new, more efficient, exposure mechanisms are defined, they should also include methods for the 5G system that determine which exposure mechanism is to be used, so that multiple mechanisms may co-exist in the system. This problem is further discussed below and demonstrated in FIG. 8.

Provisioning for Edge Service Enablement

In describing provisioning for Edge service enablement, the following assumptions or conventions may be used.

UEs may be Edge services-aware or unaware.

Edge-aware UEs are able to trigger explicit requests for services to be provided at the edge. Two ways may be available for implementing Edge-aware UEs. First manner of implementing Edge-aware UEs, by providing an Edge Enabler Client to be hosted at the UE which enable the Edge services together with network entities such as Edge Enabler Servers and Edge Enabler Configuration Servers, as described in the SA6 architecture. Note that this disclosure uses the SA6 nomenclature for these entities, however non-SA6 based implementations with equivalent entities may be envisioned. For example, an Edge Enabler Client might be called a service layer or a common services entity. Second manner of implementing Edge-aware UEs, without an Edge Enabler Client being hosted at the UE, but with a specialized protocol stack and configuration edge functionality. For example, the UE may provide a GUI that allows a user to indicate that certain applications should be allowed to access edge services. In this case, the UE protocol stack needs to be enabled UE to know how to send application data when edge computing is enabled.

Edge-unaware UEs do not have capabilities to trigger explicit requests for services to be provided at the edge. Edge-unaware UEs may have traffic routed to edge services by the network, but the UE would be generally unaware of this.

Application Clients on Edge-aware UEs (with or without EEC) may be Edge services aware or unaware.

Edge-aware Application Clients are pre-provisioned with configuration information which may be provided explicitly to the UE or an EEC hosted by the UE with information about their edge-related capabilities and requirements. Edge-aware Application Clients may be able to also trigger explicit requests for services to be provided at the edge. These requests are processed by the UE or EEC hosted on the UE before being requested from the network.

Edge-unaware Application Clients do not have the capability to trigger explicit requests for edge services, however they may be pre-provisioned with information about their capabilities and requirements which may be used by the UE or EEC hosted on the UE to configure or trigger such services. For example, a UE may provide a GUIs allowing the users to indicate on which applications to enable edge computing. The functionality enabled by the GUI may use Application Client pre-provisioned configuration information, but the Application Clients themselves may be Edge-unaware.

An Edge Data Network is a Local Data Network that supports distributed deployment of Edge Hosting Environments.

Services at Edge Data Networks are provided by Edge Computing Service Providers (ECSP) which may or may not be the same as the Mobile Network Operators (MNO).

An Edge Data Network may be configured as a LADN (e.g., when the MNO is also the ECSP), in which case its service area may be discovered as a LADN service area, based on existing 5GC procedures. However, these procedures do not enable discovery of the Edge Data Network service areas in the more general cases in which EDNs are not configured as LADN. The following descriptions address the more general case, with specific references to the LADN case.

An Edge Data Network Configuration Server is deployed/managed by either ECSP or MNO and may provide configuration services to one or more Edge Data Networks. The Configuration Server does not generally reside in the edge, rather it is part of the MNO's N6-LAN.

EDN information in 5GC. The 5GS specifies network capabilities for interworking with external Application Servers. This includes exposure capabilities via NEF, for example, exposure of the provisioning capability towards external functions. It also includes capabilities for Application Servers belonging to a third party with which the PLMN has an agreement to influence routing decisions. These capabilities, with enhancements, may be used to provide means for ECSPs to provide externally managed EDN information to EDNs.

The Application Server may provide configuration for Edge Data Networks, which may not be managed by the PLMN serving the UE: 1) to the AMF, where the information about the EDN service area is used to assist in EDN and EDNCS discovery; 2) to the SMF, where traffic information is used to influence routing, the routing influence may be used for accessing EDNCS or for providing connectivity for Edge services.

Note that the PCF may provide both AMF and SMF with corresponding policies. Below AMF and SMF configurations are independently described in detail. However, the AF may also provide a single set of provisioning information to the PCF resulting in the information being provided to both the AMF and SMF via the corresponding policies.

The AMF may be configured with any EDN related information for all EDNs which are available in any Tracking Areas of the AMF's service area and may also be configured with information about additional EDNs in the PLMN.

There may be different approaches to the way the Edge Data Network Information may be configured at the AMF, e.g., as a set of Tracking Areas. In one example, information is configured on a per DNN basis, i.e., for different UEs accessing Edge services using the same DNN, the configured Edge service area is the same, independent of UE subscription information. In a second example, information is configured on a per EDNCS basis, i.e., for different UEs accessing Edge services of the same type or from the same ECSP and the configured Edge service area is the same, independent of UE Registration Area. The UE subscription information is used to derive the type of edge services subscribed to, which in turn is used to derive a corresponding EDN-CS. Different DNNs provided by the UEs may map to the same EDN-CS.

In both examples above, the EDN information configured at the AMF may be dependent upon the factors determining the UE Registration area (e.g. Mobility Pattern and Allowed/Non-Allowed Area) or not. For example, UEs in the same EDN service area and subscribed to the same services (or using the same DNN), but with different Mobility Patterns may be mapped to different EDNCS (or EDN). The information may include, for each EDN: an EDN identifier, a Service Area (e.g., a list of corresponding TAD, a DNN or DNNs, an indicator specifying if the EDN is configured and discoverable as LADN, IDs associated with the ECSP, FQDN(s) for EDN-CS(s) associated to each or multiple DNN, and Conditional parameters to determine the EDNCS association to a DNN (e.g., per service type). The way in which this information may be used by AMF is described in the procedures described subsequently.

The SMF receives from AF, via PCF, information for traffic routing influence. When provisioning Edge configuration information in the 5GC, Application Server's requests may target a group of UE(s), for example. For such requests, the information may be stored in the UDR and PCF(s) receive corresponding notifications of the Application Server requests. The traffic routing influence information provided to the SMF may include: 1) traffic descriptor (IP filters or Application ID); 2) DNAI; 3) N6 routing information (may include IP address, port); and 4) EDNCS FQDN. The way in which this information may be used by SMF is described in procedures explained subsequently.

Handling of UE Applications that are NOT Edge Aware without EEC. Aspects disclosed herein comprise procedures that may be well suited for the case where edge services need to be provided to UE applications that are not edge aware by a UE not hosting an EEC. For example, a UE may provide a GUI that allows a user to indicate that certain applications should be allowed to access edge services. The UE protocol stack may use this indication to determine that traffic from the indicated application should be routed to an Edge Data Network.

Handling of UE Applications that are NOT Edge Aware without EEC—Registration-based UE provisioning. A UE may have to register with the network to get authorized to receive services, to enable mobility tracking, and to enable reachability. It is proposed that when the UE registers with the network, it indicates to the network that it wants to access edge computing resources of the network. This mechanism may be used in scenarios where the UEs do not host an EEC but host applications that are not edge aware and provide GUIs that allow users to indicate on which applications to enable edge computing.

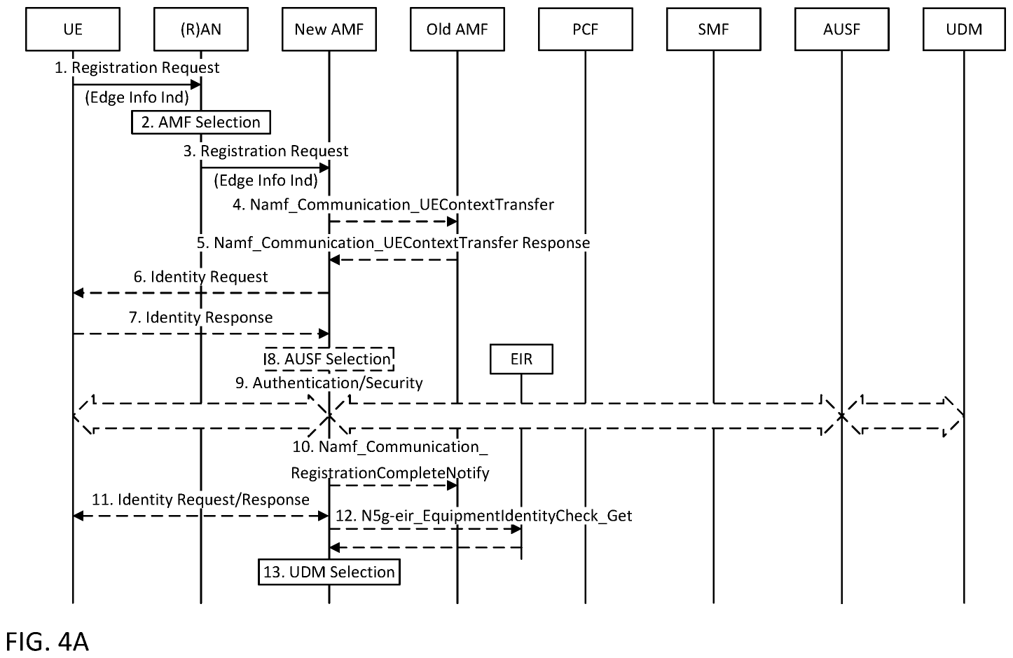

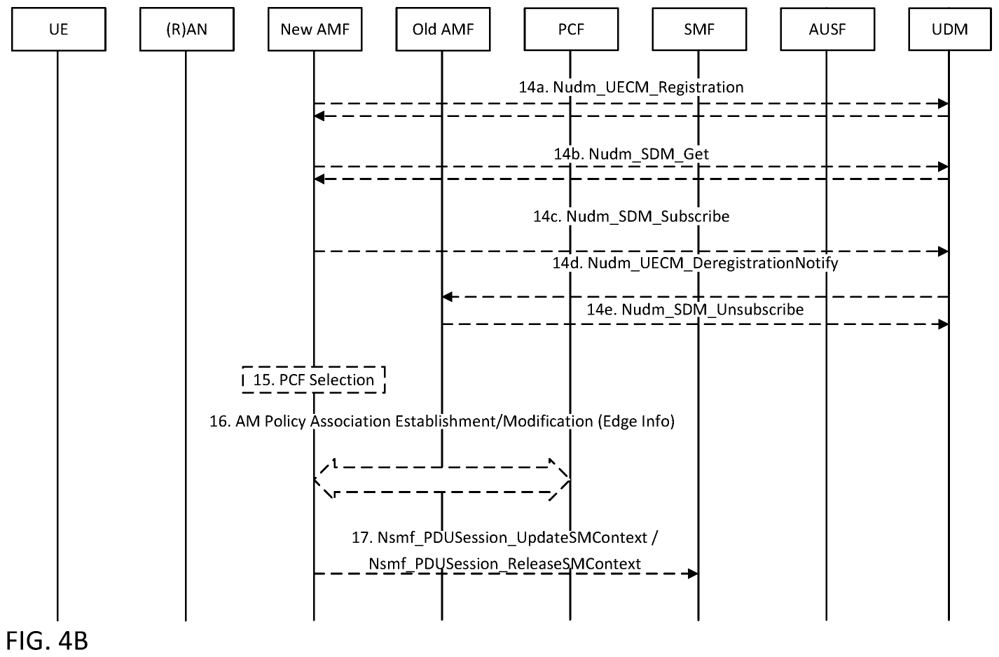

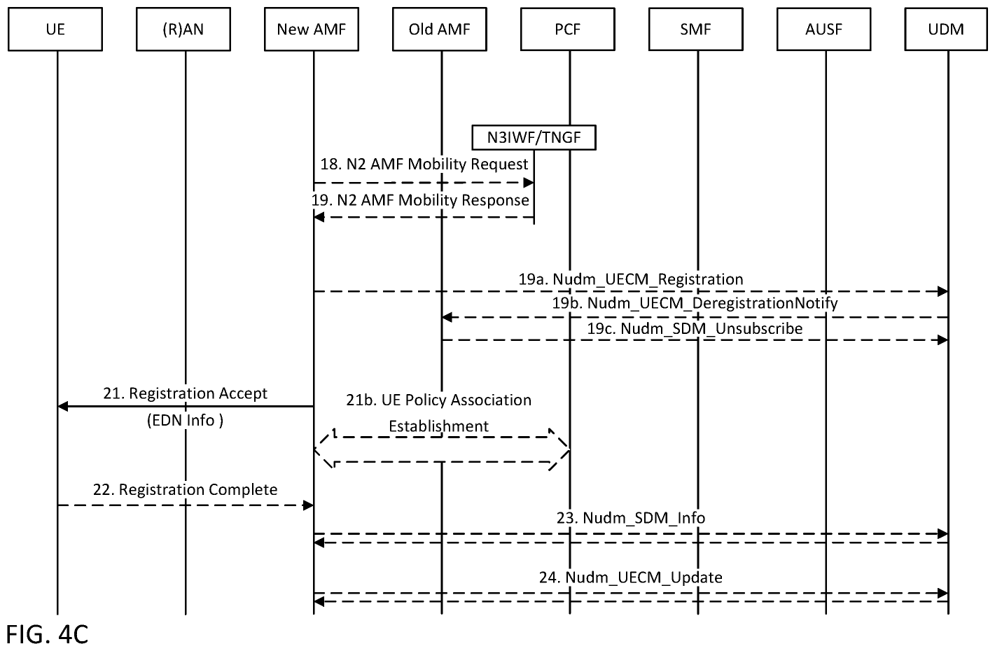

FIGS. 4A-C show an enhanced registration procedure (no EEC case) according to an aspect of this disclosure. The procedure shown in FIGS. 4A-C is an enhanced version of the General Registration procedure described in section 4.2.2.2.2 of 23.502 (See 3GPP TS 23.502, Procedures for the 5G System; Stage 2, V16.1.1 (2019-09)). The enhancements to the General Registration Procedure are as follows. In step 1 of FIG. 4A, the UE may initiate the registration procedure using registration type “Initial Registration” or “Mobility Registration Update” and may request to retrieve Edge Data Network Information by providing an EDN information indication, which is a flag and additional information that may indicate that the UE wants to access edge computing resources of the network. An EDN information indication may also include Application Descriptors (OSId and/or OSAppId(s)) to indicate to the network which specific applications on the UE should have access to edge computing services. The EDN information indication may be forward to the AMF in step 3 of FIG. 4A and to the PCF in step 16 of FIG. 4B. The PCF may use this information to determine which URSP rules to forward to the UE. The PCF may respond to the AMF with an indication of whether or not the UE can be configured with URSP rules that will enable Edge Computing. This indication may be provided by the PCF per Application Descriptor. The indication from the PCF may be provided to the UE, by the AMF, in step 21 of FIG. 4C. The PCF may further subscribe to the AMF to receive notifications when the UE's location changes so that the UE's URSP Rules that relate to edge computing can be updated.

Handling of UE Applications that are NOT Edge Aware without EEC—Use of URSP rules. URSPs are policies provided by PCF to the UE. They may be used by the UE to determine how to route outgoing traffic from the UE. Traffic may be routed to an established PDU Session, may be offloaded to non-3GPP access outside a PDU Session, or may trigger the establishment of a new PDU Session.

Using the Registration procedure enhancement described above, the UE may provide the PCF with an indication that it hosts applications whose traffic may benefit from being routed to edge services. This information (e.g., Application Descriptors) may be used by PCF, to determine that URSP rules for accessing edge services may be required. As a result, URSP rules specific to the EDNs may be returned to the UE in the registration accept response. URSP rules may also be provide to the UE in a Configuration Update procedure. In order to support this feature, the route selection components of the URSP rules may be modified to include a new Edge Enabled Indication. A route with this indication may only be considered valid if the UE is configured (e.g., via GUI) such that the associated Application Descriptor has edge services enabled. The RSD may further indicate the locations where the route can be considered valid (e.g., where the edge computing service is available.)

URSP Policies with the route descriptors including the Edge Enabled Indication may be used only if Edge computing is enabled on the UE. The Route Selection Validation Criteria may provide location (and time) context associated with the specific edge service required. The Edge Enabled Indication may be used for URSP rules that will cause the PDU Session Establishment for Edge configuration purposes to be routed to the edge services. Other URSP rules with Edge Enabled Indication may cause the PDU Session Establishment for Edge configuration purposes to be sent to the Configuration Server.

EEC Discovery of the Edge Configuration Server (URSP Based Approach). The PDU Session Establishment procedure is used in the 5GS by the UE to establish a new PDU Session, in some handover from EPS or between 3GPP and non-3GPP cases or following a Network triggered PDU Session Establishment procedure. The procedure may assume that the UE has registered, and the AMF has retrieved the user subscription data from the UDM.

In some scenarios, an Edge Enabler Client may attempt to establish IP Connectivity to an Edge Configuration Server after it has been pre-provisioned with an FQDN for an Edge Configuration Server or it has been obtained at registration. For example, the UE has discovered the EDN service areas and one of the Application Clients has been pre-provisioned with a well-known FQDN in order to access a Configuration Server. A URSP rule in the UE may cause the UE to attempt to establish a new PDU session when the FQDN is first accessed. The URSP rule may indicate to the UE that the PDU Session is used to obtain Edge Configuration data, or generally obtain operator configuration data. This mechanism may also be used for purposes other than obtaining operator or edge configuration data, e.g., for obtaining the edge services themselves. The mechanism may also be used by edge-aware UEs or applications when the FQDN has been pre-configured, rather than provided via URSP rules, for example.

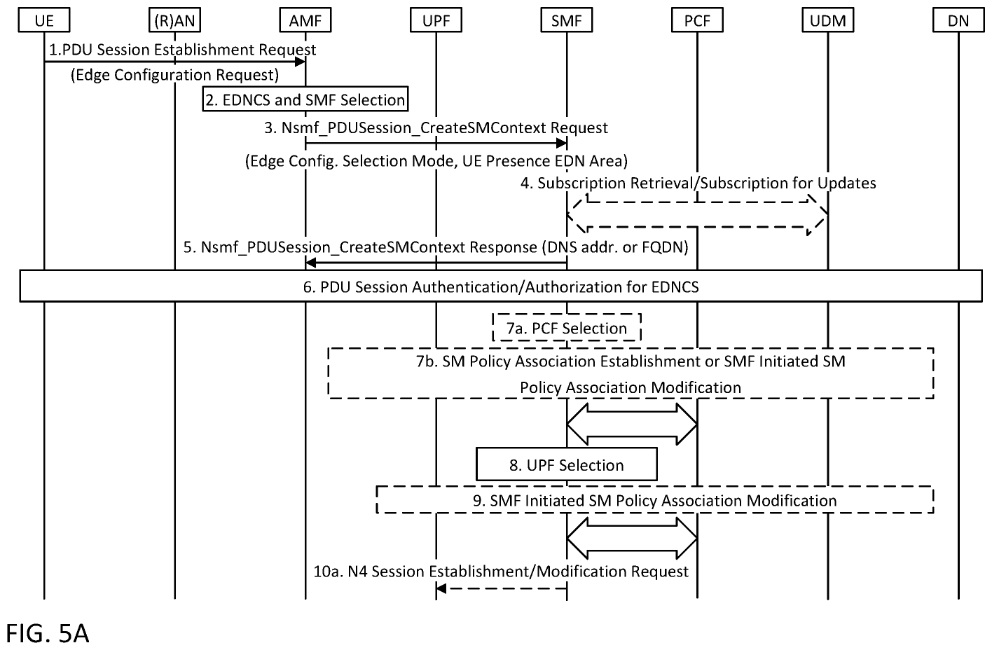

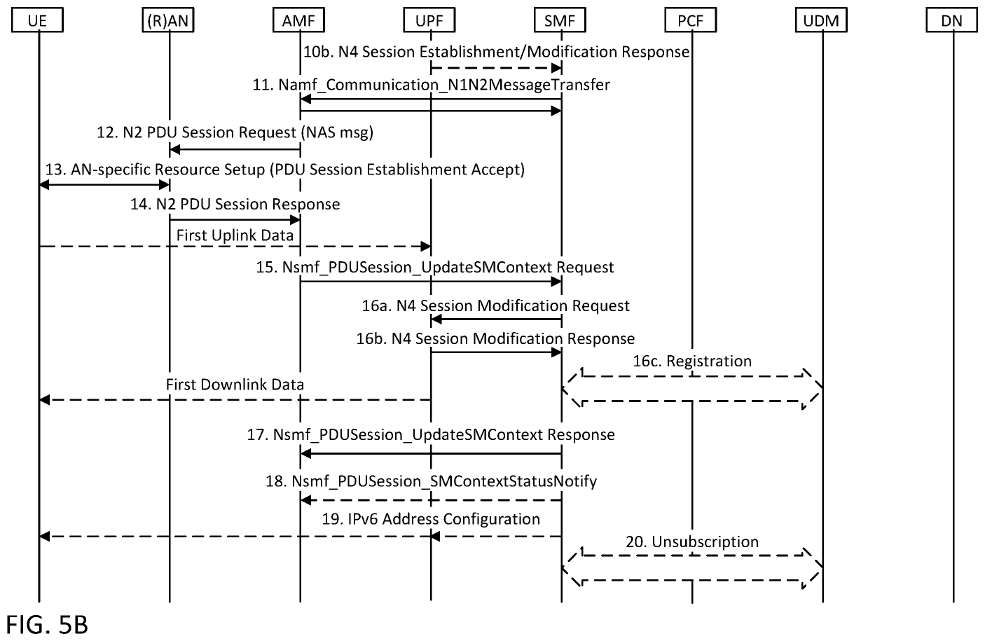

The PDU Session Establishment Procedure from section 4.3.2.2.1 of 23.502 (See 3GPP TS 23.502, Procedures for the 5G System; Stage 2, V16.1.1 (2019-09)) may be enhanced as shown in FIGS. 5A and 5B. Note that only the changes to the procedure introduced by this disclosure are detailed, all other steps are executed according to the specification.

FIGS. 5A and 5B show a call flow example of an Enhanced UE-requested PDU Session Establishment. Therein, in step 1 of FIG. 5A, the UE may send to AMF NAS Message (S-NSSAI(s), DNN, PDU Session ID, Request type, Old PDU Session ID, N1 SM container (PDU Session Establishment Request), including an Edge Configuration Request indication. The inclusion of the Edge Configuration Request indication may indicate that the PDU session will be used for the purpose of retrieving configuration information from an Edge Configuration Server.

In step 2, AMF may proceed to SMF selection and, if the Edge Configuration Request indicator is included, determining EDNCS. If the message includes a DNN corresponding to a known EDNCS, the AMF may forward that information to the SMF so that the SMF may determine what DNS Server Addresses to provide to the UE, so that the FQDN will be resolved to the IP Address of the operator's ECS. The DNS Server Addresses may be provided in multiple ways: as a simple list, as a list mapping each DNS Address to a location (e.g. cell ID), etc. If the message does not include a DNN corresponding to a known EDNCS the AMF may choose/determine, for the provided S-NSSAI: 1) an EDNCS corresponding to an available LADN; 2) an EDNCS based on priorities established from UE subscription information about the relative priorities of the Edge services subscribed to or default DNN to be used; or 3) an EDNCS based on local OAM configuration. The AMF may create an implicit subscription to “UE presence in EDN area” such that presence notifications are sent to the SMF.

In step 3, the AMF may send Nsmf_PDUSession_CreateSMContext Request to the selected SMF with an Edge Configuration Selection Mode flag to the SMF and the SMF may use this indication to determine what DNS Server Addresses should be sent to the UE in the PDU Session Establishment Response. The DNS Server Addresses may be provided in multiple ways: as a simple list, as a list mapping each DNS Address to a location (e.g. cell ID), etc. The PDU Session Establishment Response may also be used to send an indication to the UE that the PDU Session may be used to reach the Edge Configuration Server.

In step 5, SMF may send Nsmf_PDUSession_CreateSMContext Response to AMF. The response may include the FQDN of the EDNCS or may provide a DNS server address for the EDNCS to be updated at the UE (i.e., during the PDU session, as described in 3GPP TS 23.501, System Architecture for the 5G System; Stage 2, V16.3.0 (2019-12)). In step 8, the SMF may use the FQDN of the EDNCS to select an appropriate UPF. In step 10a, the SMF may send an N4 Session Establishment request in to the selected UPF and may include appropriate CN tunnel information. Then, from step 6 and on, various procedures like Optional Secondary authentication/authorization may take in consideration that the PDU session is used for configuration purposes. Steps 12 and 13 of FIG. 5B are used to transfer the response information to the UE.

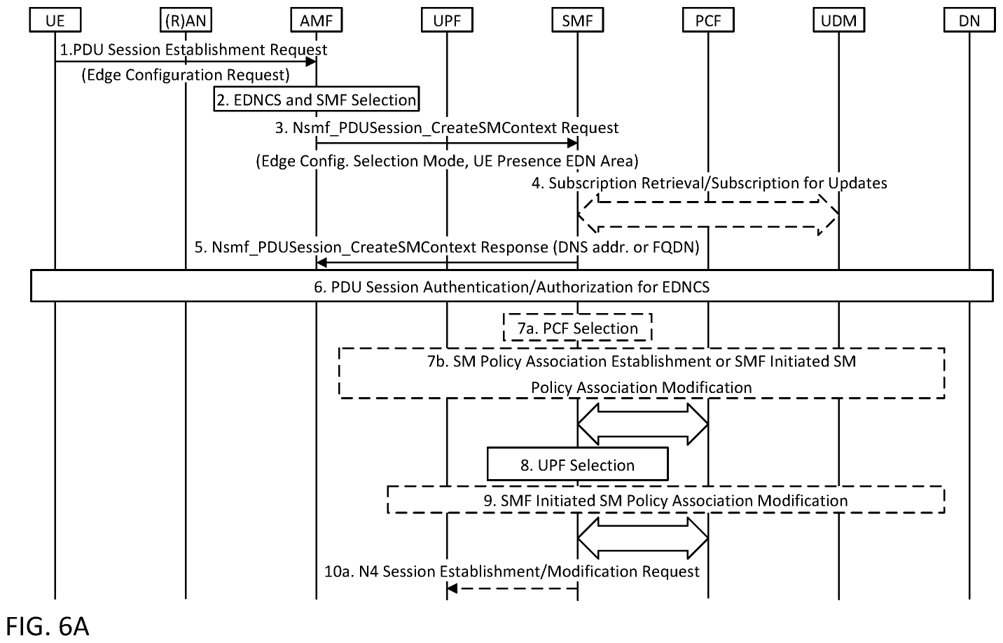

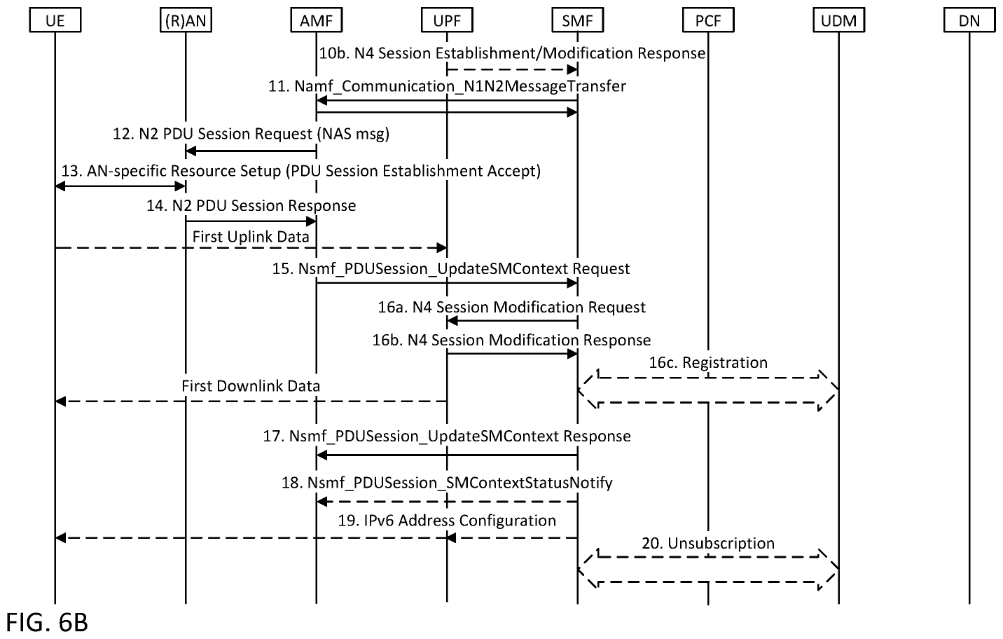

EEC Discovery of the Edge Configuration Server (Registration Based Approach). A UE may be provided with Edge Configuration Server information during registration. The enhancements to the General Registration Procedure are shown in FIGS. 6A and 6B and described as follows. In step 1 of FIG. 6A, the UE may initiate the Registration procedure using registration type “Initial Registration” or “Mobility Registration Update” and may request to discover an Edge Configuration Server by providing an EDNCS Discovery Request Indication, which is a flag and additional information that indicates that the UE wants to access edge computing resources of the network. EDNCS Discovery Request Indication may also include Application Descriptors (OSId and OSAppId(s)) to indicate to the network which specific applications on the UE should have access to edge computing services. EDN Discovery Request Indication may be forwarded to the AMF in step 3. The AMF may use this information to determine which EDNCS Discovery Information to forward to the UE.

When the UE requests the EDNCS Discovery Information via the EDN Discovery Request Indication, the AMF may identify EDNCS Discovery Information to be provided via the response to the Registration procedure. The AMF may use subscription information (existing or obtained via step 14 of FIG. 6B) to determine the services for which the UE has edge services subscriptions. The AMF may create a list of EDNs and EDNCS's available to the UE in the Registration Area to be provided to the UE in the Registration Accept (step 21 of FIG. 6B). The information provided to the UE may include, for example, for each EDN which meets the criteria to be discovered by the UE: 1) an EDN identifier; 2) a UE's authorization scope (e.g., on services or storage) on EDN; 3) a corresponding EDN Service Area (e.g., a list of corresponding TAI); 4) one or more DNNs to be used to obtain Edge services; 5) optional indicator specifying whether the EDN is configured and discoverable as LADN; 6) FQDN(s) for EDNCS(s) associated to each or multiple DNN, determined based on the conditional parameters (e.g., per service type or mobility pattern); or 7) EDNCS Discovery Information. EDNCS Discovery Information may include the following information: 1) an FQDN or IP Address of the EDNCS; 2) a list of services (e.g., Application Descriptors) for which edge services can be provided; or 3) one or more DNNs that are associated with the ECD for the UE to access. Note that the “EDN info” in step 21 of FIG. 6B includes this “EDNCS Discovery Information described above.

Note that not all the information in the list above may be available at the AMF. For example, the EDN service areas may be configured, but EDNCS information may not be available. If the UE also included a LADN DNN(s) or Indicator of Requesting LADN Information, the AMF may provide the information only for the EDNs which are configured and discoverable as LADNs. Alternatively, the UE may be able to extract this information using the optional indicator specifying if the EDN is configured and discoverable as LADN.

Based on the EDN Service Area available at the UE, the UE may later determine whether it may request PDU sessions for edge services. Alternatively, this information may be requested and provided in the UE Service Request or Configuration Update procedures. If the AMF determines that more than one applicable EDNCS are available, based on the process described above, the AMF may choose/determine, for the provided S-NSSAI: 1) an EDNCS corresponding to an available LADN; 2) an EDNCS based on priorities established from UE subscription information about the relative priorities of the Edge services subscribed to or default DNN to be used; 3) an EDNCS based on local OAM configuration. The AMF may create an implicit subscription to “UE presence in EDN area” such that presence notifications are sent to the SMF. The AMF may determine an SMF corresponding to the chosen EDNCS, or if no EDNCS can be determined the Session Establishment Request may be rejected.

Enabling Efficient Network Exposure Via the UE and Alternative Paths.

Monitoring Events may be exposed to application functions (AF) (as described in section 4.15.3 of 3GPP TS 23.502, Procedures for the 5G System; Stage 2, V16.1.1 (2019-09)). When Monitoring Events are exposed to an AF via the NEF, reports may be sent from the NF (AMF, GMLC, UDM, or SMF) that detected the events to the NEF and onto the AF. Prior to detecting an event and sending a report, the NF that detected the event may be configured for monitoring, e.g., one of the procedures in section 4.15.3.2 of TS 23.502 for AMF. Configuration usually consists of invoking a subscribe operation.

FIG. 8 is an example of an unoptimized network exposure reporting path for an edge deployment. “Local Deployment,” described herein, denotes Core Network functions (e.g., UPF or SMF) that may be dedicated for enablement of functionality in LADN and/or Edge deployments, as Local Deployment functions are generally deployed to be geographically closer to the UEs. Local Deployment functions may be depicted independently from the “Centralized” Core Network functions which are deployed independently of the location of the UEs served.

The Edge Hosting Environment may be in geographical proximity to the Local Deployment and the UE, but functionally it is not part of a CN deployment. Therefore, in an aspect of this disclosure, we consider Local Deployments to be separate from the Edge Hosting Environment, for example, a Local Deployment may serve multiple EHEs and may be managed by different providers. However, this is just a logical construct, and a Local Deployment may alternatively be considered as a part of 5GC, or to include the EHE, etc. Note also that in some 3GPP specifications (e.g., from 3GPP SA2), this concept of Local Deployment may be referred to as “Edge” or “Edge Deployment.”

FIG. 8 depicts two possibilities for AF deployment: in the Edge Hosting Environment (EHE), along with the Edge Application Server, or in a centralized cloud. The dotted lines exemplify the reporting paths to the AF(s), for reports that may be generated by either AMF or a local SMF.

FIG. 8 illustrates why the current exposure architecture might cause a problem in some edge deployments. The fact that monitoring reports need to traverse through a centralized NEF may cause unacceptable delay between event occurrence and reception of the event report at the AF, especially towards the Edge AF. Note that, although the AMF and NEF may be in the “centralized” Core Network, i.e., not in the “Edge”, they might not be close to each other. For example, the AMF, SMF, and NEF could be each in different/separate cities.

Aspects of this disclosure propose new reporting methods that may be used to send event reports when the UE is connected to an Edge Hosting Environment (EHE) via a local deployment. In an aspect, anew CN function “Local Enablement Function” (LEF) is proposed. The LEF may be a type of NEF that may be used to route monitoring reports to the AF. The AF's Monitoring Report Configuration Requests, which are not delay sensitive, may still be sent to the NEF that resides in the centralized Core Network.

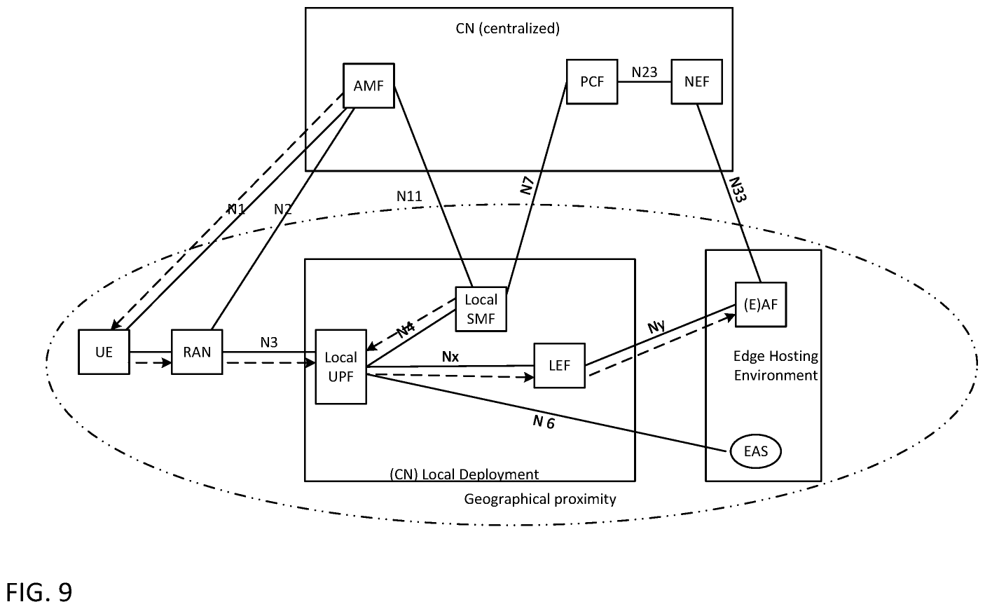

FIG. 9 is an example of an optimized reporting path from centralized network function. FIG. 9 depicts a LEF in a local deployment, used for exposure to AFs in EHEs connected to the local deployment. The dotted lines exemplify reporting paths to the edge AF(s), from either AMF or the local SMF. The reporting paths depicted correspond to methods introduced herein. Optimizations ensue by minimizing (or eliminating) the number of times messages cross the geographical boundary between the centralized NFs and the entities in geographical proximity at the edge.

Methods for Edge Reporting Subscription via a centralized NEF—Method using subscription re-targeting. The following describes how an AF may subscribe for monitoring events via the centralized NEF. As the UE moves and connects to different Local Deployments and EHEs, the subscription may be forwarded to the LEFs serving the corresponding deployments.

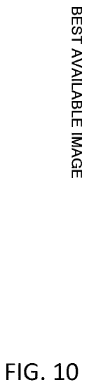

FIG. 10 is a call flow example demonstrating forwarding of edge reporting subscriptions from centralized network exposure function. The flow in FIG. 10 depicts subscription to an event which the centralized NEF forwards to the PCF, e.g., downlink delivery data status. In the flow, PCF may be replaced by UDM for other types of events, e.g., availability after DDN failure. Therefore, the forwarding functionality and flow messages described for PCF may apply to other NFs such as UDM.

To enable AFs subscribing for event monitoring via a centralized NEF, while reporting exposure is provided by the most suitable NEF or LEF for meeting reporting requirements (e.g. delay), it is proposed to enhance the report subscription procedure to include newly proposed Reporting Parameters, including reporting requirements, AF availability information, and UE routing preference indicators. The reporting requirements (e.g., delay tolerances) may be for each subscription and may also include a list of qualifiers, such that the reporting requirements provided may be applied differently based on some conditions, e.g., UE location, UE reachability status, time of day, etc. The AF availability information may be, e.g., AF location parameters, or availability times. The UE routing preference indicators may be used as a mandatory or optional requirement to include (or prefer including) the UE in the reporting path. This feature may be used when the UE may also use the report (e.g., QoS changes) for processing, instead of waiting for the AF processing based on the report. The Reporting Parameters may be used to determine which entity (e.g., NEF or LEF) is best suited for report exposure in order to meet the reporting requirements.

In step 1 of FIG. 10, AF may send Nnef_EventExposure_Subscribe Request to the centralized NEF requesting edge hosting environment-detected reporting, e.g., data delivery status. The request may include IP traffic filter and monitoring event. In step 2, NEF may send the Npcf_EventExposure_Subscribe Request to PCF. IP Filter information, monitoring event received from step 1 may be included in the message, as well as the endpoint of the requesting AF. The NEF may determine the address of the selected PCF for the PDU Session by, for example, querying the BSF.

Using the subscription Reporting Parameters proposed above, the NEF may determine the entity most suitable to support exposure of the subscribed-to reporting. To support this functionality at the BSF, the registration Nbsf Management Register operation (as described in 5.2.13.2.2 of 3GPP TS 23.502, Procedures for the 5G System; Stage 2, V16.1.1 (2019-09)) is proposed to be enhanced to include information about NEF and LEF available. That means that when the PCF invokes Nbsf_Management_Register, in addition to the tuple (UE address(es), SUPI, GPSI, DNN, DN information (e.g. S-NSSAI), PCF id) for a PDU Session and PCF id, it may also provide the suitable NEF/LEF information based on, e.g., Reporting Requirements or endpoint (AF) information.

When the subscribed-to NEF meets these requirements, the existing subscribe/notify procedures may apply. The following description addresses mainly the case in which a LEF in a Local Deployment provides the most efficient reporting exposure.

In step 3, PCF may send the Nsmf_EventExposure_Subscribe Request message to the local SMF which may serve the PDU Session relevant to the IP Filter information and may include the notification endpoint of the LEF, as well as of the requesting AF. Next, in step 4, the local SMF may send Nnef_EventExposure_Subscribe Request to the corresponding LEF, requesting exposure of the reporting. The request may include the endpoint of the requesting AF. Then, in step 5, LEF may send the Nsmf_EventExposure_Subscribe response to the local SMF, and, in step 6, local SMF may send the Npcf_EventExposure_Subscribe response message to PCF, including the LEF information. Step 7 follows wherein the PCF may send the Npcf_EventExposure_Subscribe response message to NEF, including the LEF information. In step 8, NEF may send the Nsmf_EventExposure_Subscribe response to AF, which may include the LEF information. The local SMF may detect the event, e.g., a change in Downlink Delivery Status, in step 9. And, in step 10, the SMF may send the Nsmf_EventExposure_Notify with Downlink Delivery Status event message to LEF.

For communicating with LEF, the local SMF may use the N4 interface to the local UPF and from the local UPF the Nx interface already proposed to the LEF. Alternatively, a new interface or API may be defined between the local SMF and LEF. Alternatively, a new Service Based Interface may be defined between the local SMF and the LEF and an API of the Service Based Interface may be used to send the report to the LEF. In step 11, the LEF may send Nnef_EventExposure_Notify with Downlink Delivery Status event message to AF.

Note that the messages in steps 4, 5, 10, 11 in the description above may use Nnef operations, assuming that LEF interfaces are implemented as an extension of the NEF operations currently defined by 3GPP. However, the LEF messaging may be implemented similarly but independently of the Nnef operations currently described by 3GPP.

Note that in addition to the BSF functionality enhancements proposed herein, this method relies upon the PCF determining the corresponding local SMF. This means that as a UE moves and changes connection from Local Deployment A to Local Deployment B, the PCF needs to track the subscriptions sent to the local SMF and LEF serving Local Deployment A and forward them to Local Deployment B and delete the old subscriptions. PCF may also send an update of the subscription response to NEF (corresponding to Step 7) with the new LEF. The subscription response update is forwarded by the NEF to AF (corresponding to step 8).

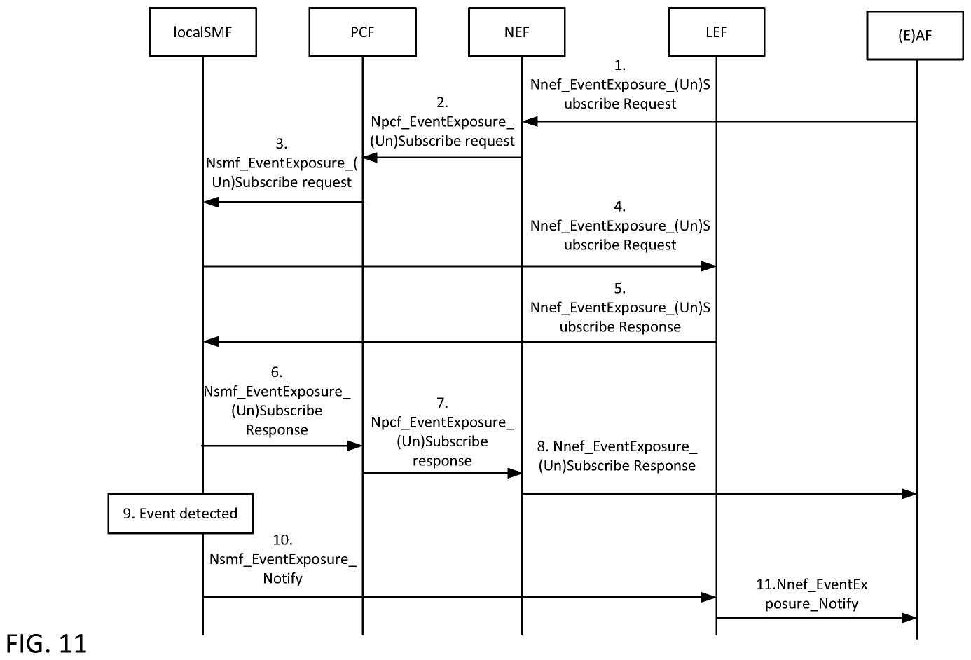

Methods for Edge Reporting Subscription via a centralized NEF—Method using policy forwarding via the UE. FIG. 11 is a call flow example demonstrating routing/distributing of edge monitoring policies via the UE. The flow in FIG. 11 describes how an AF may subscribe for monitoring events generated by NFs in the Local Deployment, via the centralized NEF. To support this method, the previously proposed Reporting Parameters may be used to enhance the AF subscription procedure. The Reporting Parameters may include reporting requirements, AF availability information, and UE routing preference indicator. The Reporting Parameters may be used to determine whether the subscription pertains to event monitoring at the edge required to be delivered in an optimized manner, e.g., via LEF in a Local Deployment. To enable the method using policy forwarding via the UE, one or more event subscriptions for AFs may be used to create an Edge Monitoring Policy (EMP).

The AMF may encapsulate the EMP in a NAS message and may send it to the UE. As the UE changes connections from one Local Deployment to another, it may provide the EMP to each local SMF via user plane messaging, using a pre-configured FQDN (or provided in the policy itself). Alternatively, the UE may provide the EMP to each local SMF via NAS-SM messaging (e.g. a PDU Session Establishment or PDU Session Modification message). When the UPF receives the message addressed to the pre-configured FQDN, it may deliver it to the local SMF associated with the PDU session. To enable this functionality, it is proposed that the UE indicates that it supports policy forwarding. The indication of support may be provided during various procedures, e.g., when registering to the core network. The network (i.e., the AMF) may use this indicator to determine whether it is permissible to send EMP to the UE.

The policy information (EMP) that may be sent from the UE to the local SMF may be used to configure the SMF. This method of delivering policies to the SMF via the UE can also be used in other cases, such as where the SMF cannot communicate directly with the PCF or cannot receive policy information from the AMF, or for delivering other policies or configuration messages from centralized NFs to NFs in local deployments.

In step 1 of FIG. 11, AF may send Nnef_EventExposure_Subscribe Request to the centralized NEF requesting edge hosting environment-detected reporting, e.g., data delivery status. The request may include IP traffic filter and monitoring events. Then, in step 2, NEF may send the request to a corresponding NF, e.g., Npcf_EventExposure_Subscribe Request to PCF. PCF may be replaced by UDM for some types of events, e.g., availability after DDN failure. IP Filter information, monitoring event received from step 1 may be included in the message, as well as the endpoint of the requesting AF. The NEF may determine the address of the selected PCF for the PDU Session by querying the BSF.

In Step 3, the PCF or UDM may create a corresponding EMP or may modify an existing one to include the new subscription. The EMP may for example be created by PCF and stored in UDM. The EMP may also be forwarded to AMF, where it is encapsulated in a NAS message for the UE to which the monitoring pertains. The EMP may contain information about one or more monitoring events, and one or more receiving AFs. EMPs which may be distributed using this method may include the following:
a policy identifier, which provides a unique ID for the policy;
a UE identification filter, which provides a way of identifying the UE(s) the monitoring policy applies to. The filter may be expressed as, e.g., an IP filter or subscription correlation ID;
a notification endpoint, associated with the endpoint information of the receiving AF. This may include more than one receiving AF;
a measurement or a message type identifier (e.g., downlink delivery data status Event ID), determining which measurement or message types should be generated in the Local Deployment and sent to the AF(s) for which the policy applies;
notification parameters, which may include, e.g., time windows during which the event notifications should be forwarded to the AFs. The notification criteria are used by the local SMFs to configure event monitoring. The notification parameters may include LEF information, or the LEF information may be pre-configured at the local SMF;
policy applicability criteria, specifying which Local Deployments it should be apply to, e.g., by indicating a geographical area, specific LADN information, etc. The policy applicability criteria may be used by local SMFs in validating the policies or configuring the monitoring; and
policy delivery criteria, specifying other criteria defining how the UE should deliver the EMP to Local Deployments. For example, the policy delivery criteria may indicate to the UE that an AMF trigger is required in order to trigger delivery. In another example, the criteria may indicate that the UE should trigger EMP delivery for any new LADN detected, periodically, etc. These criteria may also indicate if the UE should use a pre-configured FQDN for EMP delivery or may configure another specific FQDN.

In step 4, the AMF may send the EMP to the UE using a NAS message. The NAS message may contain the EMP and instructions for how to send the report to local SMFs as it connects to Local Deployments. For example, the policy delivery criteria described above may be included in the NAS message instead as being contained in the policy itself.

When the UE connects with a new Local Deployment, the subsequent steps of FIG. 11 are repeated for each new Local Deployment. In step 5, the UE may detect the new Local Deployment, e.g., by detecting a new LADN. Alternatively, the UE may be triggered by AMF, after connecting to the Local Deployment. Then in step 6, the UE may send the EMP encapsulated in an UP message to the local UPF, which may then forward the message to the local SMF, using the policy delivery criteria specified in the EMP or in the NAS message received from AMF. The UE may be configured with a DNN and or an S-NSSAI that may be used for sending the EMP's to the SMF. The UE may be configured with a URSP rule that indicates that traffic that carries EMP should be routed towards a particular DNN and/or S-NSSAI. In step 7, the local SMF may configure the monitoring in the Local Deployment. The Local SMF may configure other NFs implemented in the Local Deployment (e.g. NWDAF) to provide the monitoring reports. An event may be detected in step 8 by the local SMF. The event may alternatively be detected by other NFs implemented in the Local Deployment. In step 9, the local SMF may send the Nsmf_EventExposure_Notify with the monitored event to the LEF and the LEF may send the Nnef_EventExposure_Notify with the monitored event message to the AF in step 10.

The method described above for distributing the subscription information provided by the AF via a centralized NF (i.e., NEF) may be used for distribution of any policy or configuration information provided via a centralized NF to NFs in Local Deployments along the path of the UE. The method can be also used to distribute policy or configuration information provided via centralized NF to servers in Edge Hosting Environments connected to Local Deployments.

Methods for Reporting to Edge Servers—Method for centralized NF events reporting via the UE. When an event is detected in the central Core Network (e.g., by the AMF of FIG. 8) and the AF is in the edge, it may be not efficient to send the report to the edge via the NEF. As illustrated in FIG. 8, sending the report via the NEF may cause a significant delay. In an aspect, it is proposed that, if the UE is connected to a Local/Edge Deployment and the AF that should receive the report is in the edge, then the AMF may send the report via the UE using a NAS message. The NAS message may contain the Event Report and instructions (i.e., an address) for how to send the report to the AF. For example, the following information may be sent to the UE:
an Event Report, that describes an event such as a location change, a change on SUPI/PEI association, a change in MICO mode settings, UE reachable report, QoS targets can no longer (or can again) be fulfilled, or QoS Monitoring parameters;
an IP Address or FQDN of an LEF that should receive the report;
a DNN or S-NSSAI that should be used associated with the PDU Session that is used to send the report to the UE;
an AF Identifier that identifies the AF that the LEF should forward the report to; and
a Transaction Reference ID that may be used by the AF to correlate the report with the AF's earlier request to receive the report.

This method may be further used for forwarding monitoring reports from AMF or other NFs in the centralized Core Network, when the UE is reachable. This method also may support subscriptions with Reporting Parameters preciously introduced, where the UE routing preference indicator mandates or indicates preference for UE routing. This is especially useful for cases, such as QoS monitoring, in which the UE acting directly upon the report, without waiting for AF actions or commands, is beneficial. At the same time, the AF may also be informed of the report via an optimized path.

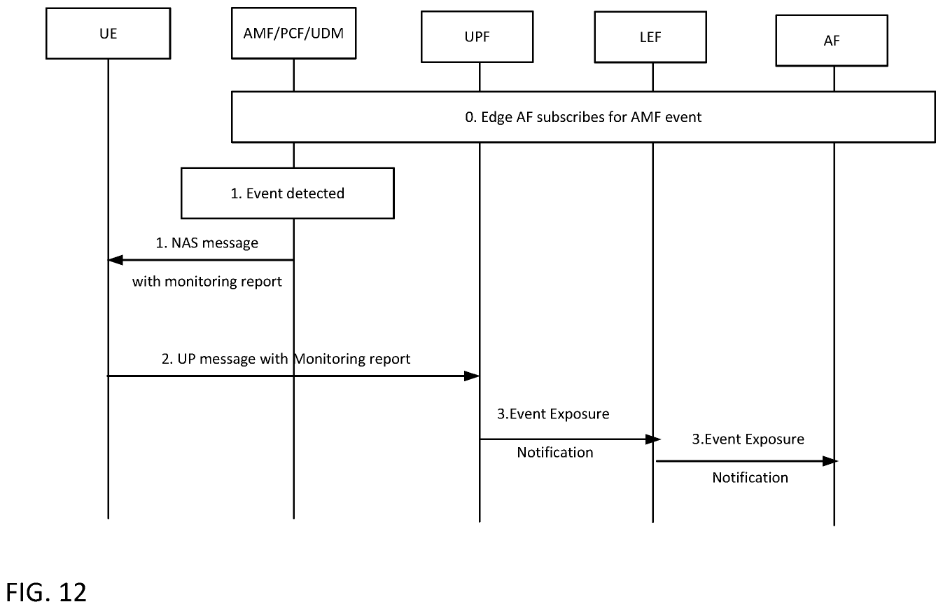

FIG. 12 is a call flow example demonstrating reporting routing from centralized NF via the UE. FIG. 12 depicts the high-level flow method for monitoring reporting being routed from a centralized NF (e.g., AMF) via UE to an AF located in an EHE.

After the UE receives a monitoring report from the AMF in step 2 of FIG. 12, it may send the monitoring report to the LEF via the local UPF in step 3. When the UE sends the monitoring report to the LEF, the UE may choose to use an existing PDU Session that is already associated with the DNN and S-NSSAI that was provided by the AMF when the monitoring report was sent to the UE. Alternatively, the UE may use the DNN and S-NSSAI that was provided by the AMF to establish a new PDU Session and use the new PDU Session to send the report. The UE may also forward, to the LEF, information such as AF Identifier so that the LEF can determine what AF to forward the report to. The UE may also include other information such as a timestamp that indicates when the report was received from the AMF, the Transaction Reference ID that was received from the AMF, etc.

The UPF may use an interface or API to send the report to the LEF in step 4. For example, the Nx interface in FIG. 9 may be an N6 based interface and IP based routing may be used to send the report to the NEF. Alternatively, a new Service Based Interface may be defined between the UPF and the LEF and an API of the Service Based Interface may be used to send the report to the LEF.

The LEF then may expose the information to the Edge AF in step 5, using the same APIs used at the centralized NEF (FIG. 9). The Ny interface supports Edge AF to LEF interface and may be realized as an N33/Nnef interface which is defined in TS 29.122. This API may be enhanced to indicate to the Edge AF that the report came via the UE because the UE is connected to the AF via an edge environment.

To enable this functionality, it is proposed that the UE indicates that it supports routing monitoring reports to the Edge. The indication of support may be provided during various procedures, e.g., when registering to the core network, as part of a PDU Session establishment procedure. The network (i.e., the AMF) may use this indicator to determine whether it is permissible to send monitoring reports to the UE.

To enable this functionality, it is proposed also that the Core Network provides an Edge Monitoring Routing Policy (EMRP) to the UE. The UE may use EMRPs to receive monitoring reports and may route them to the LEF, who in turn may expose the information to the Edge AF(s) that requested it.

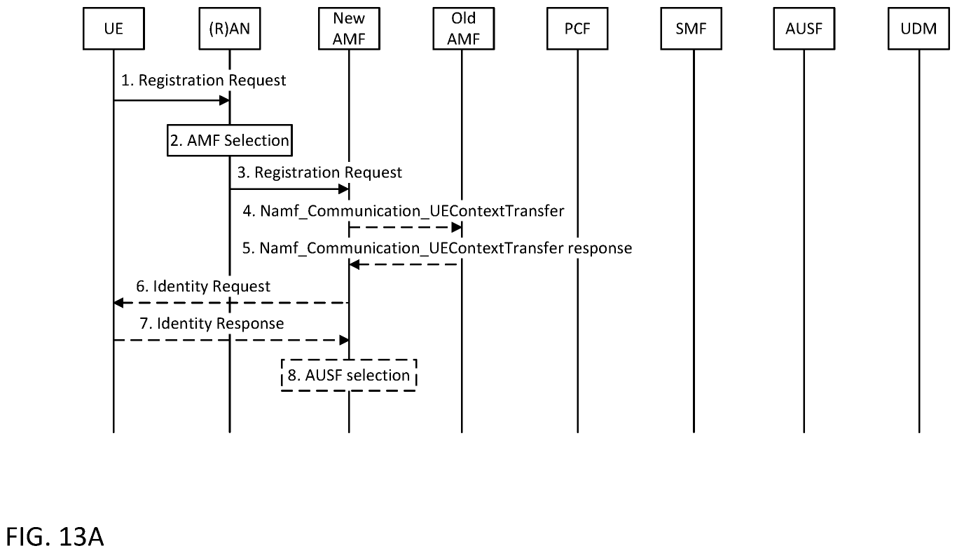

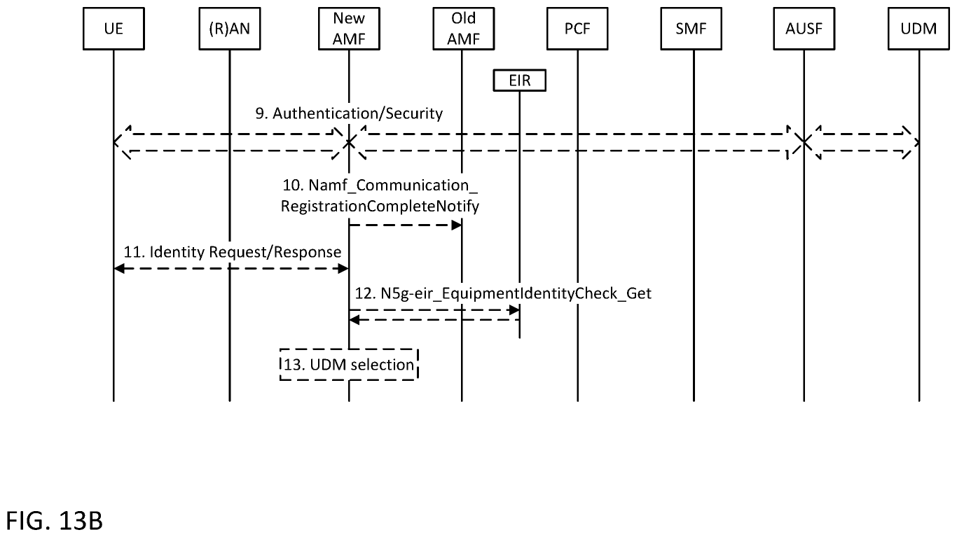

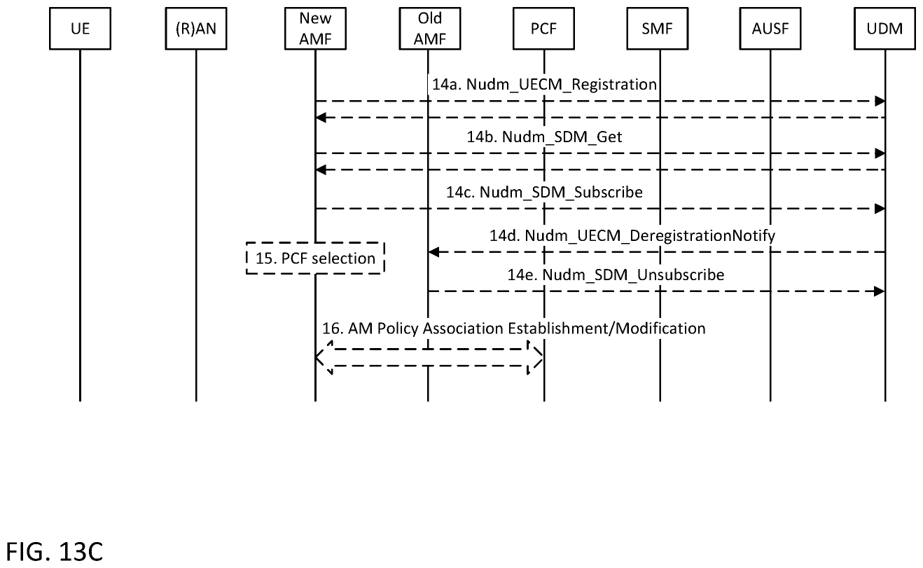

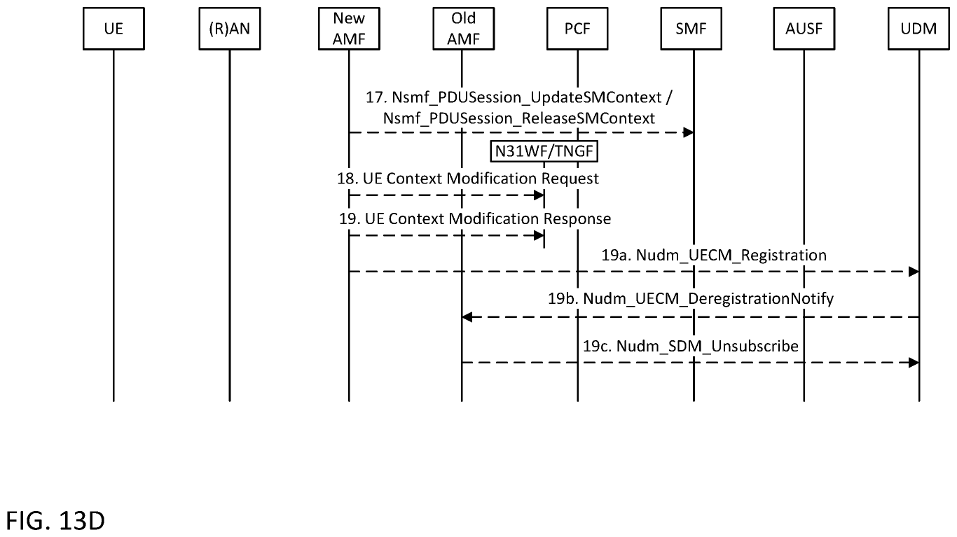

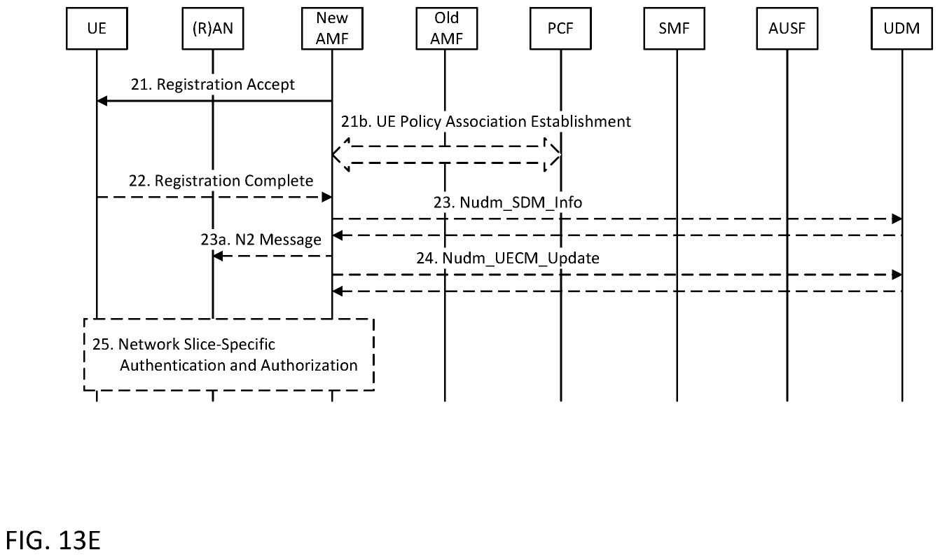

FIGS. 13A-E show a call flow example of an enhanced registration procedure enabling a UE to communicate its support for routing monitoring reports. FIGS. 13A-E depict the general registration procedure (as described in 3GPP TS 23.502, Procedures for the 5G System; Stage 2, V16.1.1 (2019-09)), enhanced to allow a UE to communicate its support for routing monitoring reports to the LEF.

The following enhancements are proposed in the procedure shown in FIGS. 13A-E in order to enable the UE to support routing monitoring reports to the LEF.

In step 1 of FIG. 13A, the UE includes a LEF reporting capability indicator within the Registration request to inform the core network that the UE is capable of receiving monitoring reports from the AMF and is capable of providing monitoring reports to the LEF. This registration request may be forwarded to the AMF in step 3.

In step 16 of FIG. 13C, the AMF includes the LEF reporting capability indicator to the PCF when establishing an AM Policy Association for the UE. PCF creates a new Edge Monitoring Routing Policy (EMRP) policy or updates an existing one. The information used by PCF to create/update the policy may include UE location, subscribed service area restrictions (from AMF, based on UDM information). PCF obtains also information about the monitoring enabled for the UE by querying various NFs (e.g. AMF, GMLC, UDM). The PCF may be provisioned with information about available LEF as part of network configuration or policy. The EMRP policy may include:
a) a policy identifier, which provides a unique ID for the policy;
b) a DNN which identifies the data network the UE is connected to when routing monitoring reports to a given LEF;
c) an IP address or FQDN of the LEF for which the policy applies;
d) a notification endpoint associated with the endpoint information of the receiving AF;
e) a measurement or message type identifier (e.g., Event ID), determining which measurement or message types should be forwarded to the LEF for which the policy applies; and
f) an indicator of application layer level exposure of LEF information. This is a binary indicator that allows the UE to send the LEF information to AFs using application layer signaling. This is useful for supporting AFs at the edge to discover the LEFs that they should connect to. AFs in general may be pre-provisioned with information about centralized NEFs. However, with the proliferation of edge deployments, pre-provisioning with information about all LEFs, when the ECSP is different than the MNO, may not be feasible. Instead, the UE can send this information at the application level to the AF based on the received EMRP.

In step 21 of FIG. 13E, the EMRP is returned to the UE in the Registration Accept message. If the UE had not included a LEF reporting capability indicator in step 1, the AMF may prompt the UE if it wants to provide LEF reporting in the Registration Accept message.

In step 22, if the UE was prompted by the AMF to provide its LEF reporting capability, the UE returns the indicator to the AMF in the Registration Complete message. Upon receiving the LEF reporting capability indicator, the AMF may trigger the execution of a UE Configuration Update procedure for transparent UE Policy delivery to generate and send the EMRP. After receiving the EMRP, the UE routes the monitoring reporting specified by the policy and sends them to the LEF.

The UE may alternatively send the LEF reporting capability indicator as part of a PDU Session establishment procedure. In this scenario the UE includes the indicator in the PDU Session Establishment request or when modifying a PDU session. The SMF receives the indicator and forwards it to the PCF. The EMRP is generated by the PCF and returned to the UE in the PDU Session Establishment Accept response. Examples of existing types of AMF monitoring reports using this method are: UE reachability, Location Reporting, Availability after Downlink Data Notification failure, etc.

Examples of existing types of PCF monitoring reports using this method are: Change of Access Type, signaling path status, QoS targets can no longer (or can again) be fulfilled, QoS Monitoring parameters.

Another event that is detected in the central core network of FIG. 8 is the change of the QoS of an ongoing PDU Session (TS 23.503 section 6.1.3.22). This report can be sent via the SMF and NAS signaling.

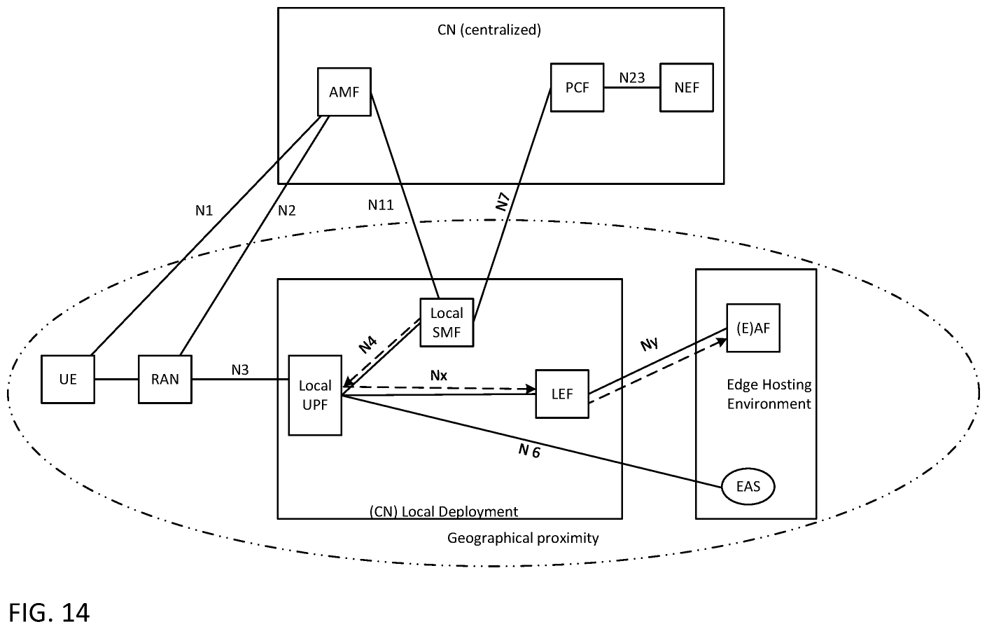

Methods for Reporting to Edge Servers—Method for Edge-deployed NF events routing. FIG. 14 is an example of optimized reporting path from a locally deployed NF. When an event is detected in the edge (e.g., downlink delivery data status by the SMF of FIG. 14) and the AF is in the edge, it is efficient to send the report to the AF via a path that does not leave the edge.

For reports generated by other NFs in a local deployment (e.g., NWDAF), the PCF may generate Edge Monitoring Policies (EMP) which are applicable for all (or a set of) UEs connected to a local deployment and which are provided to the local SMFs. EMPs may be generated or stored by other NFs, e.g., UDM for the availability after DDN failure events. Edge Monitoring Policies provided to local SMFs may include:
a policy identifier, which provides a unique ID for the policy;
a UE identification filter, which provides a way of identifying the UE(s) the monitoring the policy applies to, the filter may be expressed, for example, as an IP filter or a subscription correlation ID;
a notification endpoint associated with the endpoint information of the receiving AF that may include more than one receiving AF;
a measurement or a message type identifier (e.g., downlink delivery data status Event ID), determining which measurement or message types should be forwarded to the LEF for which the policy applies;
a notification parameters, including an address (e.g., IP address) for the LEF for which the policy applies, the notification parameters may include other criteria (e.g., time windows) for event notifications forwarding to the AFs, such notification criteria may be used by the local SMFs to configure the event monitoring and for notification routing; and
policy applicability criteria, specifying which Local Deployments it should be apply to e.g. by indicating a geographical area, specific LADN information, etc. The policy applicability criteria may be used by local SMFs in validating the policies or configuring the monitoring.

The Local SMF may use the Edge Monitoring Policies to determine how to configure the monitoring and may send the monitoring reports. The Local SMF may configure other NFs implemented in the Local Deployment (e.g., NWDAF) to provide the monitoring reports. Based on this configuration, the reports identified by filtering based on the UE identification filter and the measurement or message type identifier are generated and sent to the LEF indicated by the policy. The message sent by the Local SMF to the LEF contains also the notification endpoint provided by the policy, which is used by the LEF to determine where to forward the report.

For reporting events generated by local NFs in many cases existing interfaces can be reused. For example, the local SMF may use the N4 interface to the local UPF. From the local UPF the reports may use the interfaces already proposed, namely the Nx interface between the local UPF and the LEF, and the Ny interface between the LEF and the (E)AF. Alternatively, a new interface or API may be defined between the local SMF and LEF. In another alternative, a new Service Based Interface may be defined between the local SMF and the LEF and an API of the Service Based Interface may be used to send the report to the LEF. New interfaces/APIs or service-based interfaces may also be defined between other locally deployed NFs (e.g. NWDAF) and the LEF.

1-7. (canceled)

8. A Wireless Transmit/Receive Unit, WTRU hosting an Edge Enabler Client, EEC, the WTRU comprising a processor, communication circuitry connected to a network, and a memory, the memory comprising computer-executable instructions which, when executed by the processor, cause the WTRU to:
send, to the network, a Non-access Stratum, NAS, request comprising an Edge Data Network Configuration Server, EDNCS, discovery request indication, the EDNCS discovery request indication indicating that the WTRU wishes to access edge computing resources of the network; and
receive, from the network, an NAS response comprising EDNCS discovery information.

9. The WTRU of claim 8, wherein the EDNCS discovery information comprises at least one identifier of an EDNCS.

10. The WTRU of claim 9, wherein the identifier of the EDNCS is a Fully-qualified Domain Name.

11-12. (canceled)

13. The WTRU of claim 8, wherein the instructions further cause the WTRU to determine, based at least in part on the EDNCS discovery information, to establish a PDU Session.

14. The WTRU of claim 8, wherein the instructions further cause the WTRU to determine, based at least in part on the EDNCS discovery information, to obtain edge services.

15. (canceled)

16. A server hosting a network function, NF, the server comprising a processor, communication circuitry connected to a network, and a memory, the memory comprising computer-executable instructions which, when executed by the processor, cause the server to:
receive, from a Wireless Transmit/Receive Unit, WTRU, an NAS request comprising an Edge Data Network Configuration Server, EDNCS, discovery request indication, the EDNCS discovery request indication indicating to the NF that the WTRU wishes to access edge computing resources of the network; and
send, to the WTRU, an NAS response comprising EDNCS discovery information.

17. The server of claim 16, wherein the EDNCS discovery information comprises at least one identifier of an EDNCS.

18. The server of claim 17 wherein the identifier is a Fully-qualified Domain Name, FQDN.

19. (canceled)

20. The server of claim 16, wherein the instructions further cause the NF to derive the EDNCS discovery information from subscription information of the WTRU.

21. The server of claim 17 wherein the identifier an Internet protocol, IP, address.

22. The WTRU of claim 9, wherein the instructions further cause the WTRU to determine, based at least in part on the EDNCS discovery information, to establish a PDU Session.

23. The WTRU of claim 9, wherein the identifier of the EDNCS is an Internet protocol, IP, address.

24. The WTRU of claim 23, wherein the instructions further cause the WTRU to determine, based at least in part on the EDNCS discovery information, to establish a PDU Session.

25. The WTRU of claim 10, wherein the instructions further cause the WTRU to determine, based at least in part on the EDNCS discovery information, to establish a PDU Session.

26. The WTRU claim 9, wherein the instructions further cause the WTRU to determine, based at least in part on the EDNCS discovery information, to obtain edge services.

27. The WTRU claim 10, wherein the instructions further cause the WTRU to determine, based at least in part on the EDNCS discovery information, to obtain edge services.

28. The WTRU claim 23, wherein the instructions further cause the WTRU to determine, based at least in part on the EDNCS discovery information, to obtain edge services.
